(19) United States
(12) Patent Application Publication
(10) Pub. No.: US 2026/0149804 A1
(43) Pub. Date: May 28, 2026

(54) Template-based Intra Mode Derivation with Directional Samplewise Fusion

(71) Applicant: Ofinno, LLC, Reston, VA (US)

(72) Inventors: Pierre Jean Andrivon, Liffre (FR); Médéric Blestel, Bruz (FR)

(73) Assignee: Ofinno, LLC, Reston, VA (US)

(21) Appl. No.: 19/446,487

(22) Filed: Jan. 12, 2026

Related U.S. Application Data
(63) Continuation of application No. PCT/US2024/037346, filed on Jul. 10, 2024.
(60) Provisional application No. 63/525,936, filed on Jul. 10, 2023.
(60) Provisional application No. 63/542,931, filed on Oct. 6, 2023.

(51) Int. Cl. H04N 19/11; H04N 19/105; H04N 19/132; H04N 19/156; H04N 19/176; H04N 19/593

(52) U.S. Cl. CPC H04N 19/11; H04N 19/105; H04N 19/132; H04N 19/156; H04N 19/176; H04N 19/593

(57) ABSTRACT

A coder determines, based on template-based intra mode derivation (TIMD) being applied for a block, a plurality of costs of a plurality of intra prediction modes (IPMs) applied to predict a template of the block. TIMD modes are determined based on IPMs from the plurality of IPMs. For each of the TIMD modes: a weight is determined based on a cost of the TIMD mode, and a directionality of the TIMD mode is determined based on comparing a first sub-cost, of the cost, for a first region of the template and a second sub-cost, of the cost, for a second region of the template. A TIMD mode predictor is determined based on a linear combination of the TIMD modes having weights that are adjusted according to the directionalities of the TIMD modes. Based on the TIMD mode predictor, the coder generates a prediction block for coding the current block.

### CROSS-REFERENCE TO RELATED APPLICATIONS

This application is a continuation of International Application No. PCT/US2024/037346, filed Jul. 10, 2024, which claims the benefits of U.S. Provisional Application No. 63/525,936, filed Jul. 10, 2023, and U.S. Provisional Application No. 63/542,931, filed Oct. 6, 2023, all of which are hereby incorporated by reference in their entireties.

### BRIEF DESCRIPTION OF THE DRAWINGS

Some features are shown by way of example, and not by limitation, in the accompanying drawings. In the drawings, like numerals reference similar elements.

FIG. 1 shows an example video coding/decoding system in which embodiments of the present disclosure may be implemented.

FIG. 2 shows an example encoder in which embodiments of the present disclosure may be implemented.

FIG. 3 shows an example decoder in which embodiments of the present disclosure may be implemented.

FIG. 4 shows an example quadtree partitioning of a coding tree block (CTB).

FIG. 5 shows an example quadtree corresponding to the example quadtree partitioning of the CTB in FIG. 4.

FIG. 6 show examples of binary tree and ternary tree partitions.

FIG. 7 shows an example of combined quadtree and multi-type tree partitioning of a CTB.

FIG. 8 shows an example tree corresponding to the combined quadtree and multi-type tree partitioning of the CTB shown in FIG. 7.

FIG. 9 shows an example set of reference samples determined for intra prediction of a current block.

FIGS. 10A and 10B show example intra prediction modes.

FIG. 11 shows an example of a current block and corresponding reference samples.

FIG. 12 shows an example of applying an intra prediction mode (e.g., an angular mode) for prediction of a current block.

FIG. 13A shows an example of inter prediction performed for a current block in a current picture.

FIG. 13B shows an example motion vector.

FIG. 14 shows an example of bi-prediction performed for a current block.

FIG. 15A shows example spatial candidate neighboring blocks relative to a current block being coded.

FIG. 15B shows example locations of two temporal, co-located blocks relative to a current block.

FIG. 16 shows an example of intra block copy (IBC).

FIG. 17A shows an example of decoder-side intra mode derivation (DIMD) for coding a current block, according to some embodiments.

FIG. 17B shows an example of template-based intra mode derivation (TIMD) for coding a current block, according to some embodiments.

FIG. 18 shows an example of signaling TIMD for decoding a current block, according to some embodiments.

FIG. 19A shows a flowchart of an example method for applying a TIMD technique with directional samplewise fusion for a current block, according to some embodiments.

FIG. 19B shows a flowchart of an example method for applying a TIMD technique with directional samplewise fusion for a current block, according to some embodiments.

FIG. 20 shows a flowchart of an example method for applying a TIMD technique with direction al samplewise fusion for a current block, according to some embodiments.

FIG. 21 shows a flowchart of an example method for applying a TIMD technique with directional samplewise fusion for a current block, according to some embodiments.

FIG. 22 shows a block diagram of an example computer system in which embodiments of the present disclosure may be implemented.

### DETAILED DESCRIPTION

In the following description, numerous specific details are set forth in order to provide a thorough understanding of the disclosure. However, it will be apparent to those skilled in the art that the disclosure, including structures, systems, and methods, may be practiced without these specific details. The description and representation herein are the common means used by those experienced or skilled in the art to most effectively convey the substance of their work to others skilled in the art. In other instances, well-known methods, procedures, components, and circuitry have not been described in detail to avoid unnecessarily obscuring aspects of the disclosure.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

Also, it is noted that individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

Furthermore, embodiments may be implemented by hardware, software, firmware, middleware, microcode, hardware description languages, or any combination thereof. When implemented in software, firmware, middleware or microcode, the program code or code segments to perform the necessary tasks (e.g., a computer-program product) may be stored in a computer-readable or machine-readable medium. A processor(s) may perform the necessary tasks.

A video sequence, comprising multiple pictures/frames, may be represented in digital form for storage and/or transmission. Representing a video sequence in digital form may require a large quantity of bits. Large data sizes that may be associated with video sequences may require significant resources for storage and/or transmission. Video encoding may be used to compress a size of a video sequence for more efficient storage and/or transmission. Video decoding may be used to decompress a compressed video sequence for display and/or other forms of consumption.

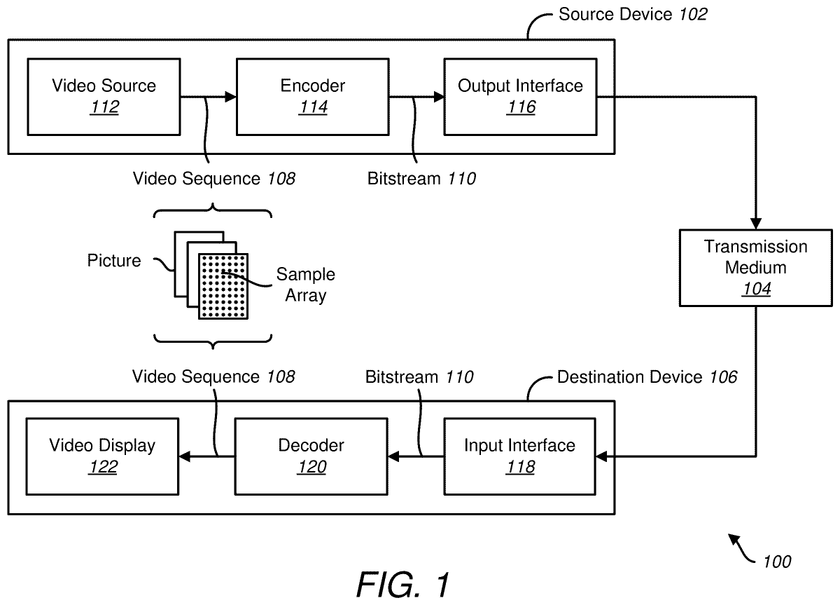

FIG. 1 shows an example video coding/decoding system 100 in which embodiments of the present disclosure may be implemented. Video coding/decoding system 100 comprises a source device 102, a transmission medium 104, and a destination device 106. Source device 102 encodes a video sequence 108 into a bitstream 110 for more efficient storage and/or transmission. Source device 102 may store and/or send/transmit bitstream 110 to destination device 106 via transmission medium 104. Destination device 106 decodes bitstream 110 to display video sequence 108. Destination device 106 may receive bitstream 110 from source device 102 via transmission medium 104. Source device 102 and/or destination device 106 may be any of a plurality of different devices (e.g., a desktop computer, laptop computer, tablet computer, smart phone, wearable device, television, camera, video gaming console, set-top box, video streaming device, etc.).

Source device 102 may comprise (e.g., for encoding video sequence 108 into bitstream 110) one or more of a video source 112, an encoder 114, and/or an output interface 116. Video source 112 may provide and/or generate video sequence 108 based on a capture of a natural scene and/or a synthetically generated scene. A synthetically generated scene may be a scene comprising computer generated graphics and/or screen content. Video source 112 may comprise a video capture device (e.g., a video camera), a video archive comprising previously captured natural scenes and/or synthetically generated scenes, a video feed interface to receive captured natural scenes and/or synthetically generated scenes from a video content provider, and/or a processor to generate synthetic scenes.

A video sequence, such as video sequence 108, may comprise a series of pictures (also referred to as frames). A video sequence may achieve an impression of motion based on successive presentation of pictures of the video sequence using a constant time interval or variable time intervals between the pictures. A picture may comprise one or more sample arrays of intensity values. The intensity values may be taken (e.g., measured, determined, provided) at a series of regularly spaced locations within a picture. A color picture may comprise (e.g., typically comprises) a luminance sample array and two chrominance sample arrays. The luminance sample array may comprise intensity values representing the brightness (e.g., luma component, Y) of a picture. The chrominance sample arrays may comprise intensity values that respectively represent the blue and red components of a picture (e.g., chroma components, Cb and Cr) separate from the brightness. Other color picture sample arrays may be possible based on different color schemes (e.g., a red, green, blue (RGB) color scheme). A pixel, in a color picture, may refer to/comprise/be associated with all intensity values (e.g., luma component, chroma components), for a given location, in the sample arrays (e.g., three sample arrays are used for one luma component and two chroma components, respectively) used to represent color pictures. A monochrome picture may comprise a single, luminance sample array. A pixel, in a monochrome picture, may refer to/comprise/be associated with the intensity value (e.g., luma component) at a given location in the single, luminance sample array used to represent monochrome pictures.

Encoder 114 may encode video sequence 108 into bitstream 110. Encoder 114 may apply/use (e.g., to encode video sequence 108) one or more prediction techniques to reduce redundant information in video sequence 108. Redundant information is information that may be predicted at a decoder and need not be transmitted to the decoder for accurate decoding of video sequence 108. For example, encoder 114 may apply spatial prediction (e.g., intra-frame or intra prediction), temporal prediction (e.g., inter-frame prediction or inter prediction), inter-layer prediction, and/or other prediction techniques to reduce redundant information in video sequence 108. Encoder 114 may partition pictures comprising video sequence 108 into rectangular regions referred to as blocks, for example, before applying one or more prediction techniques. Encoder 114 may then encode a block using the one or more of the prediction techniques.

For temporal prediction, encoder 114 may search for a block similar to the block being encoded in another picture (e.g., referred to as a reference picture) of video sequence 108. The block determined during the search (e.g., referred to as a prediction block) may then be used to predict the block being encoded. For spatial prediction, encoder 114 may form a prediction block based on data from reconstructed neighboring samples of the block to be encoded within the same picture of video sequence 108. A reconstructed sample refers to a sample that was encoded and then decoded. Encoder 114 may determine a prediction error (e.g., also referred to as a residual) based on the difference between a block being encoded and a prediction block. The prediction error may represent non-redundant information that may be sent/transmitted to a decoder for accurate decoding of video sequence 108.

Encoder 114 may apply a transform to the prediction error (e.g. using a discrete cosine transform (DCT), or any other transform) to generate transform coefficients. Encoder 114 may form bitstream 110 based on the transform coefficients and other information used to determine prediction blocks using/based on prediction types, motion vectors, and/or prediction modes. Encoder 114 may perform one or more of quantization and entropy coding of the transform coefficients and/or the other information used to determine the prediction blocks, for example, before forming bitstream 110. The quantization and/or the entropy coding may further reduce the quantity of bits needed to store and/or transmit video sequence 108.

Output interface 116 may be configured to write and/or store bitstream 110 onto transmission medium 104 for transmission to destination device 106. In addition or alternatively, output interface 116 may be configured to send/transmit, upload, and/or stream bitstream 110 to destination device 106 via transmission medium 104. Output interface 116 may comprise a wired and/or a wireless transmitter configured to send/transmit, upload, and/or stream bitstream 110 in accordance with one or more proprietary, open-source, and/or standardized communication protocols (e.g., Digital Video Broadcasting (DVB) standards, Advanced Television Systems Committee (ATSC) standards, Integrated Services Digital Broadcasting (ISDB) standards, Data Over Cable Service Interface Specification (DOCSIS) standards, 3rd Generation Partnership Project (3GPP) standards, Institute of Electrical and Electronics Engineers (IEEE) standards, Internet Protocol (IP) standards, Wireless Application Protocol (WAP) standards, and/or any other communication protocol).

Transmission medium 104 may comprise wireless, wired, and/or computer readable medium. For example, transmission medium 104 may comprise one or more wires, cables, air interfaces, optical discs, flash memory, and/or magnetic memory. In addition or alternatively, transmission medium 104 may comprise one or more networks (e.g., the internet) or file servers configured to store and/or send/transmit encoded video data.

Destination device 106 may decode bitstream 110 into video sequence 108 for display. Destination device 106 may comprise one or more of an input interface 118, a decoder 120, and/or a video display 122. Input interface 118 may be configured to read bitstream 110 stored on transmission medium 104 by source device 102. In addition or alternatively, input interface 118 may be configured to receive, download, and/or stream bitstream 110 from source device 102 via transmission medium 104. Input interface 118 may comprise a wired and/or a wireless receiver configured to receive, download, and/or stream bitstream 110 in accordance with one or more proprietary, open-source, standardized communication protocols, and/or any other communication protocol (e.g., such as referenced herein).

Decoder 120 may decode video sequence 108 from encoded bitstream 110. The decoder 120 may generate prediction blocks for pictures of video sequence 108 in a similar manner as encoder 114 and determine the prediction errors for the blocks, for example, to decode video sequence 108. Decoder 120 may generate the prediction blocks using/based on prediction types, prediction modes, and/or motion vectors received in bitstream 110. Decoder 120 may determine the prediction errors using the transform coefficients received in bitstream 110. Decoder 120 may determine the prediction errors by weighting transform basis functions using the transform coefficients. Decoder 120 may combine the prediction blocks and the prediction errors to decode video sequence 108. Video sequence 108 at the destination device 106 may be, or may not necessarily be, the same video sequence sent, such as video sequence 108 as sent by the source device 102. Decoder 120 may decode a video sequence that approximates video sequence 108, for example, because of lossy compression of video sequence 108 by encoder 114 and/or errors introduced into encoded bitstream 110 during transmission to destination device 106.

Video display 122 may display video sequence 108 to a user. Video display 122 may comprise a cathode rate tube (CRT) display, a liquid crystal display (LCD), a plasma display, a light emitting diode (LED) display, and/or any other display device suitable for displaying video sequence 108.

Video coding/decoding system 100 is merely an example and video encoding/decoding systems different from the video coding/decoding system 100 and/or modified versions of the video coding/decoding system 100 may similarly perform the methods and processes as described herein. For example, the video coding/decoding system 100 may comprise other components and/or arrangements. For example, video source 112 may be external to source device 102. Similarly, video display 122 may be external to destination device 106 or omitted altogether (e.g., if video sequence 108 is intended for consumption by a machine and/or storage device). In an example, source device 102 may further comprise a video decoder and destination device 106 may further comprise a video encoder. For example, source device 102 may be configured to further receive an encoded bitstream from destination device 106 to support two-way video transmission between the devices.

Encoder 114 and/or decoder 120 may operate according to one or more proprietary or industry video coding standards. For example, encoder 114 and/or decoder 120 may operate in accordance with one or more proprietary, open-source, and/or standardized protocols (e.g., International Telecommunications Union Telecommunication Standardization Sector (ITU-T) H.263, ITU-T H.264 and Moving Picture Expert Group (MPEG)-4 Visual (also known as Advanced Video Coding (AVC)), ITU-T H.265 and MPEG-H Part 2 (also known as High Efficiency Video Coding (HEVC)), ITU-T H.265 and MPEG-I Part 3 (also known as Versatile Video Coding (VVC)), the WebM VP8 and VP9 codecs, and/or AOMedia Video 1 (AV1), and/or any other video coding protocol).

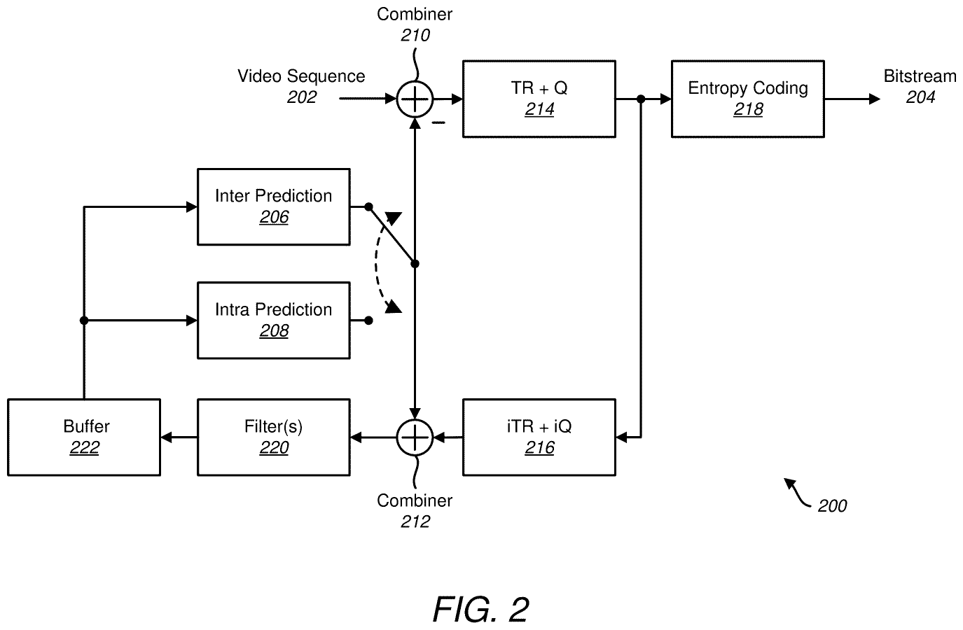

FIG. 2 shows an example encoder. Encoder 200 as shown in FIG. 2 may implement one or more processes described herein. Encoder 200 may encode a video sequence 202 into a bitstream 204 for more efficient storage and/or transmission. Encoder 200 may be implemented in video coding/decoding system 100 as shown in FIG. 1 (e.g., as encoder 114) or in any computing, communication, or electronic device (e.g., desktop computer, laptop computer, tablet computer, smart phone, wearable device, television, camera, video gaming console, set-top box, video streaming device, etc.). Encoder 200 may comprise one or more of an inter prediction unit 206, an intra prediction unit 208, combiners 210 and 212, a transform and quantization unit (TR+Q) 214, an inverse transform and quantization unit (iTR+iQ) 216, an entropy coding unit 218, one or more filters 220, and/or a buffer 222.

Encoder 200 may partition pictures (e.g., frames) of (e.g., comprising) video sequence 202 into blocks and encode video sequence 202 on a block-by-block basis. Encoder 200 may perform/apply a prediction technique on a block being encoded using either inter prediction unit 206 or intra prediction unit 208. Inter prediction unit 206 may perform inter prediction by searching for a block similar to the block being encoded in another, reconstructed picture (e.g., a reference picture) of video sequence 202. A reconstructed picture refers to a picture that was encoded and then decoded. The block determined during the search (e.g., referred to as a prediction block) may then be used to predict the block being encoded to remove redundant information. Inter prediction unit 206 may exploit temporal redundancy or similarities in scene content from picture to picture in video sequence 202 to determine the prediction block. For example, scene content between pictures of video sequence 202 may be similar except for differences due to motion and/or affine transformation of the screen content over time.

Intra prediction unit 208 may perform intra prediction by forming a prediction block based on data from reconstructed neighboring samples of the block to be encoded within the same picture of video sequence 202. A reconstructed sample refers to a sample that was encoded and then decoded. Intra prediction unit 208 may exploit spatial redundancy or similarities in scene content within a picture of video sequence 202 to determine the prediction block. For example, the texture of a region of scene content in a picture may be similar to the texture in the immediate surrounding area of the region of the scene content in the same picture.

Combiner 210 may determine a prediction error (e.g., referred to as a residual) based on the difference between the block being encoded and the prediction block. The prediction error may represent non-redundant information that may be sent/transmitted to a decoder for accurate decoding of video sequence 202.

Transform and quantization unit (TR+Q) 214 may transform and quantize the prediction error. Transform and quantization unit 214 may transform the prediction error into transform coefficients by applying, for example, a DCT to reduce correlated information in the prediction error. Transform and quantization unit 214 may quantize the coefficients by mapping data of the transform coefficients to a predefined set of representative values. Transform and quantization unit 214 may quantize the coefficients to reduce irrelevant information in bitstream 204. The irrelevant information refers to information that may be removed from the coefficients without producing visible and/or perceptible distortion in video sequence 202 after decoding (e.g., at a receiving device).

Entropy coding unit 218 may apply one or more entropy coding methods to the quantized transform coefficients to further reduce the bit rate. For example, entropy coding unit 218 may apply context adaptive variable length coding (CAVLC), context adaptive binary arithmetic coding (CABAC), and/or syntax-based context-based binary arithmetic coding (SBAC). The entropy coded coefficients may be packed to form bitstream 204.

Inverse transform and quantization unit (iTR+iQ) 216 may inverse quantize and inverse transform the quantized transform coefficients to determine a reconstructed prediction error. Combiner 212 may combine the reconstructed prediction error with the prediction block to form a reconstructed block. Filter(s) 220 may filter the reconstructed block, for example, using a deblocking filter and/or a sample-adaptive offset (SAO) filter. Buffer 222 may store the reconstructed block for prediction of one or more other blocks in the same and/or different picture of video sequence 202.

Encoder 200 may further comprise an encoder control unit. The encoder control unit may be configured to control one or more units of encoder 200 as shown in FIG. 2. The encoder control unit may control the one or more units of encoder 200 such that bitstream 204 may be generated in conformance with the requirements of one or more proprietary coding protocols, industry video coding standards, and/or any other video cording protocol. For example, the encoder control unit may control the one or more units of encoder 200 such that bitstream 204 may be generated in conformance with one or more of ITU-T H.263, AVC, HEVC, VVC, VP8, VP9, AV1, and/or any other video coding standard/format.

The encoder control unit may be configured to attempt to minimize (or reduce) the bitrate of bitstream 204 and/or maximize (or increase) the reconstructed video quality (e.g., within the constraints of a proprietary coding protocol, industry video coding standard, and/or any other video cording protocol). For example, the encoder control unit may be configured to attempt to minimize or reduce the bitrate of bitstream 204 such that the reconstructed video quality does not fall below a certain level/threshold, and/or to maximize or increase the reconstructed video quality such that the bitrate of bitstream 204 does not exceed a certain level/threshold. The encoder control unit may determine/control one or more of: partitioning of the pictures of video sequence 202 into blocks, whether a block is inter predicted by inter prediction unit 206 or intra predicted by intra prediction unit 208, a motion vector for inter prediction of a block, an intra prediction mode among a plurality of intra prediction modes for intra prediction of a block, filtering performed by filter(s) 220, and/or one or more transform types and/or quantization parameters applied by transform and quantization unit 214. The encoder control unit may determine/control one or more of the above based on a rate-distortion measure for a block or picture being encoded. The encoder control unit may determine/control one or more of the above to reduce the rate-distortion measure for a block or picture being encoded.

The prediction type used to encode a block (intra or inter prediction), prediction information of the block (intra prediction mode if intra predicted, motion vector, etc.), and/or transform and/or quantization parameters, may be sent to entropy coding unit 218 to be further compressed (e.g., to reduce the bitrate). For example, entropy coding unit 218 may apply context adaptive variable length coding (CAVLC), context adaptive binary arithmetic coding (CABAC), and/or syntax-based context-based binary arithmetic coding (SBAC) to achieve further compression. The prediction type, prediction information, and/or transform and/or quantization parameters may be packed with the prediction error to form bitstream 204.

Encoder 200 is merely an example and encoders different from encoder 200 and/or modified versions of encoder 200 may perform the methods and processes as described herein. For example, encoder 200 may comprise other components and/or arrangements. One or more of the components shown in FIG. 2 may be optionally included in encoder 200 (e.g., entropy coding unit 218 and/or filters(s) 220).

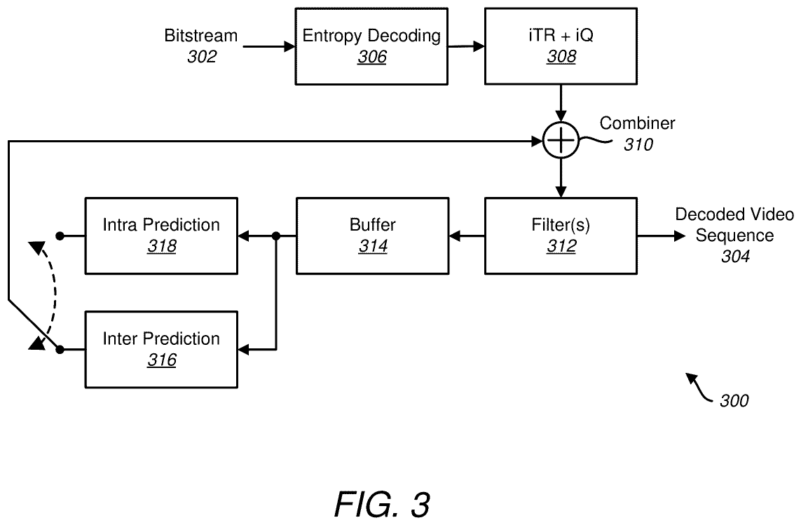

FIG. 3 shows an example decoder. A decoder 300 as shown in FIG. 3 may implement one or more processes described herein. Decoder 300 may decode a bitstream 302 into a decoded video sequence 304 for display and/or some other form of consumption. Decoder 300 may be implemented in video coding/decoding system 100 in FIG. 1 and/or in a computing, communication, or electronic device (e.g., desktop computer, laptop computer, tablet computer, smart phone, wearable device, television, camera, video gaming console, set-top box, and/or video streaming device). Decoder 300 may comprise an entropy decoding unit 306, an inverse transform and quantization (iTR+iQ) unit 308, a combiner 310, one or more filters 312, a buffer 314, an inter prediction unit 316, and/or an intra prediction unit 318. Decoder 300 may comprise a decoder control unit configured to control one or more units of decoder 300. The decoder control unit may control the one or more units of decoder 300 such that bitstream 302 is decoded in conformance with the requirements of one or more proprietary coding protocols, industry video coding standards, and/or any other communication protocol. For example, the decoder control unit may control the one or more units of decoder 300 such that the bitstream 302 is decoded in conformance with one or more of ITU-T H.263, AVC, HEVC, VVC, VP8, VP9, AV1, and/or any other video coding standard/format.

The decoder control unit may determine/control one or more of: whether a block is inter predicted by inter prediction unit 316 or intra predicted by intra prediction unit 318, a motion vector for inter prediction of a block, an intra prediction mode among a plurality of intra prediction modes for intra prediction of a block, filtering performed by filter(s) 312, and/or one or more inverse transform types and/or inverse quantization parameters to be applied by inverse transform and quantization unit 308. One or more of the control parameters used by the decoder control unit may be packed in bitstream 302.

Entropy decoding unit 306 may entropy decode the bitstream 302. For example, entropy decoding unit 306 may apply context adaptive variable length coding (CAVLC), context adaptive binary arithmetic coding (CABAC), and syntax-based context-based binary arithmetic coding (SBAC) to decompress the prediction type used to encode a block (intra or inter prediction), prediction information of the block (intra prediction mode if intra predicted, motion vector, etc.), and transform and quantization parameters. Inverse transform and quantization unit 308 may inverse quantize and/or inverse transform the quantized transform coefficients to determine a decoded prediction error. Combiner 310 may combine the decoded prediction error with a prediction block to form a decoded block. The prediction block may be generated by intra prediction unit 318 or inter prediction unit 316 (e.g., as described above with respect to encoder 200 in FIG. 2). Filter(s) 312 may filter the decoded block, for example, using a deblocking filter and/or a sample-adaptive offset (SAO) filter. Buffer 314 may store the decoded block for prediction of one or more other blocks in the same and/or different picture of the video sequence in bitstream 302. Decoded video sequence 304 may be output from filter(s) 312 as shown in FIG. 3.

Decoder 300 is merely an example and decoders different from decoder 300 and/or modified versions of decoder 300 may perform the methods and processes as described herein. For example, decoder 300 may have other components and/or arrangements. One or more of the components shown in FIG. 3 may be optionally included in decoder 300 (e.g., entropy decoding unit 306 and/or filters(s) 312).

Although not shown in FIGS. 2 and 3, each of encoder 200 and decoder 300 may further comprise an intra block copy unit in addition to inter prediction and intra prediction units. The intra block copy unit may perform/operate similar to an inter prediction unit but may predict blocks within the same picture. For example, the intra block copy unit may exploit repeated patterns that appear in screen content. The screen content may include computer generated text, graphics, animation, etc.

Video encoding and/or decoding may be performed on a block-by-block basis. The process of partitioning a picture into blocks may be adaptive based on the content of the picture. For example, larger block partitions may be used in areas of a picture with higher levels of homogeneity to improve coding efficiency.

A picture (e.g., in HEVC, or any other coding standard/format) may be partitioned into non-overlapping square blocks, which may be referred to as coding tree blocks (CTBs). The CTBs may comprise samples of a sample array. A CTB may have a size of 2nx2n samples, where n may be specified by a parameter of the encoding system. For example, n may be 4, 5, 6, or any other value. A CTB may have any other size. A CTB may be further partitioned by a recursive quadtree partitioning into coding blocks (CBs) of half vertical and half horizontal size. The CTB may form the root of the quadtree. A CB that is not split further as part of the recursive quadtree partitioning may be referred to as a leaf CB of the quadtree, and otherwise may be referred to as a non-leaf CB of the quadtree. A CB may have a minimum size specified by a parameter of the encoding system. For example, a CB may have a minimum size of 4×4, 8×8, 16×16, 32×32, 64×64 samples, or any other minimum size. A CB may be further partitioned into one or more prediction blocks (PBs) for performing inter and/or intra prediction. A PB may be a rectangular block of samples on which the same prediction type/mode may be applied. For transformations, a CB may be partitioned into one or more transform blocks (TBs). A TB may be a rectangular block of samples that may determine/indicate an applied transform size.

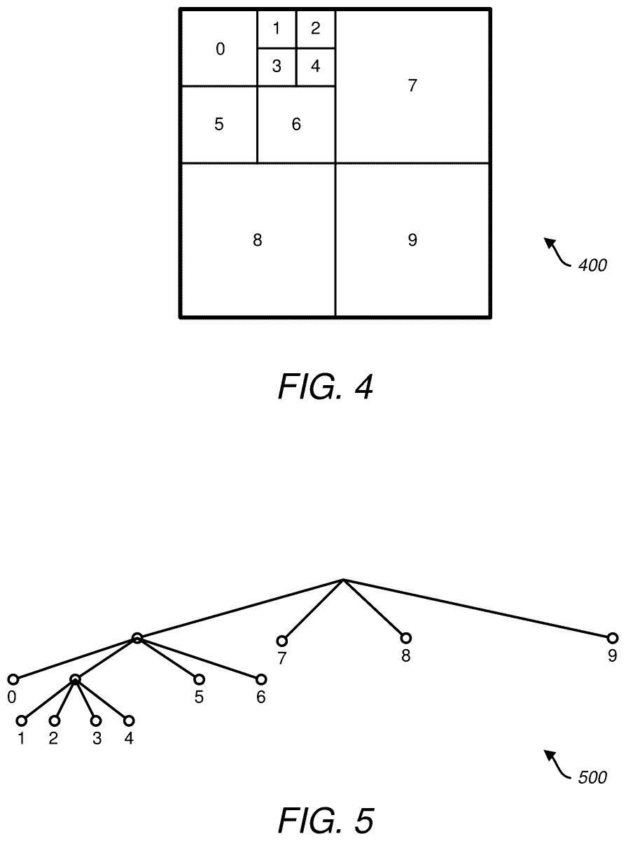

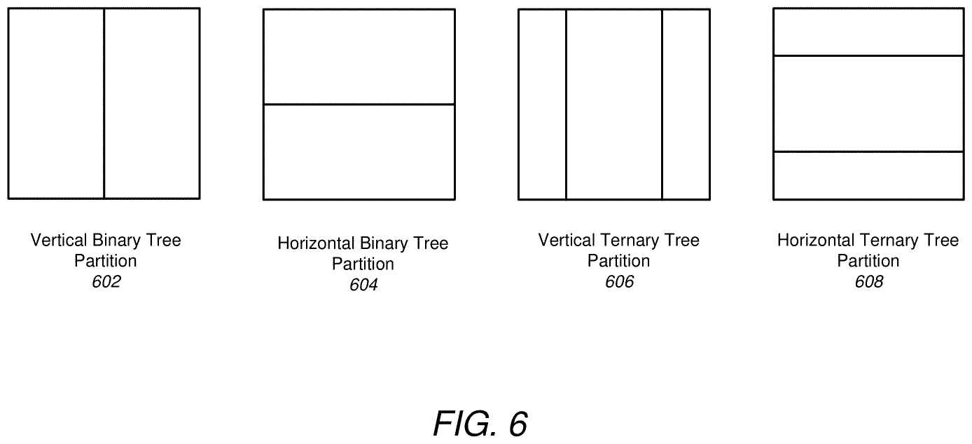

FIG. 4 shows an example quadtree partitioning of a CTB 400. FIG. 5 shows an example quadtree 500 corresponding to the example quadtree partitioning of CTB 400 in FIG. 4. As shown in the examples of FIGS. 4 and 5, CTB 400 may first be partitioned into four CBs of half vertical and half horizontal size. Three of the resulting CBs of the first level partitioning of CTB 400 are leaf CBs. The three leaf CBs of the first level partitioning of CTB 400 are respectively labeled 7, 8, and 9 in FIGS. 4 and 5. The non-leaf CB of the first level partitioning of CTB 400 is partitioned into four sub-CBs of half vertical and half horizontal size. Three of the resulting sub-CBs of the second level partitioning of CTB 400 are leaf CBs. The three leaf CBs of the second level partitioning of CTB 400 are respectively labeled 0, 5, and 6 in FIGS. 4 and 5. Finally, the non-leaf CB of the second level partitioning of CTB 400 is partitioned into four leaf CBs of half vertical and half horizontal size. The four leaf CBs are respectively labeled 1, 2, 3, and 4 in FIGS. 4 and 5.

The example CTB 400 of FIG. 4 is partitioned into 10 leaf CBs respectively labeled 0-9, but may be partitioned into other quantities of leaf CBs. The 10 leaf CBs may correspond to 10 CB leaf nodes (e.g., 10 CB leaf nodes of quadtree 500 as shown in FIG. 5). In other examples, a CTB may be partitioned into a different number of leaf CBs. The resulting quadtree partitioning of CTB 400 may be scanned using a z-scan (e.g., left-to-right, top-to-bottom) to form the sequence order for encoding/decoding the CB leaf nodes. A numeric label (e.g., indicator, index) of each CB leaf node in FIGS. 4 and 5 may correspond to the sequence order for encoding/decoding. For example, CB leaf node 0 may be encoded/decoded first and CB leaf node 9 may be encoded/decoded last. Although not shown in FIGS. 4 and 5, each CB leaf node may comprise one or more PBs and/or TBs.

A picture, in VVC (or in any other coding standard/format), may be partitioned in a similar manner (such as in HEVC). A picture may be first partitioned into non-overlapping square CTBs. The CTBs may then be partitioned, using a recursive quadtree partitioning, into CBs of half vertical and half horizontal size. A quadtree leaf node (e.g., in VVC) may be further partitioned by a binary tree or ternary tree partitioning (or any other partitioning) into CBs of unequal sizes.

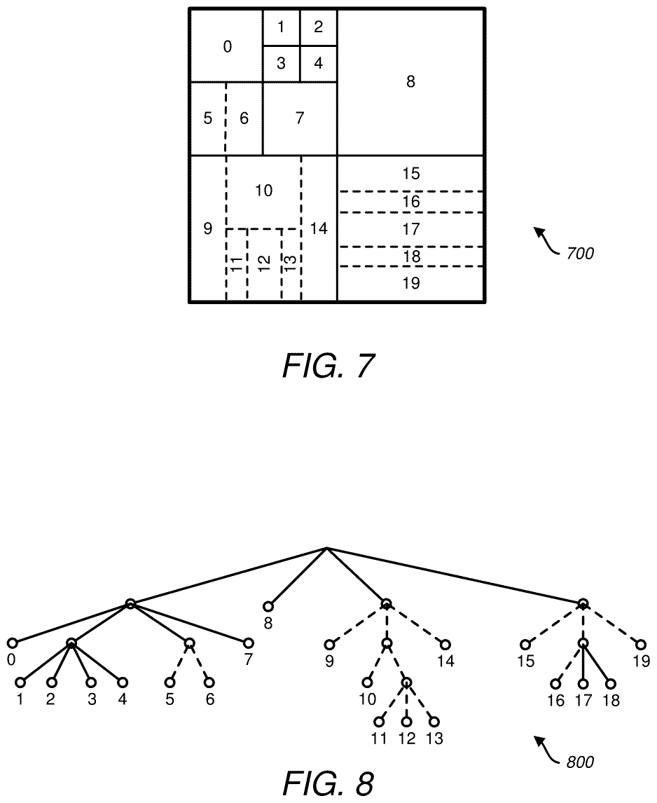

FIG. 6 shows example binary tree and ternary tree partitions. A binary tree partition may divide a parent block in half in either a vertical direction 602 or a horizontal direction 604. The resulting partitions may be half in size as compared to the parent block. In other examples, the resulting partitions may correspond to sizes that are less than and/or greater than half of the parent block size. A ternary tree partition may divide a parent block into three parts in either a vertical direction 606 or a horizontal direction 608. FIG. 6 shows an example in which the middle partition may be twice as large as the other two end partitions in the ternary tree partitions. In other examples, partitions may be of other sizes relative to each other and to the parent block. Binary and ternary tree partitions are examples of multi-type tree partitioning. Multi-type tree partitions may comprise partitioning a parent block into other quantities of smaller blocks. The block partitioning strategy (e.g., in VVC) may be referred to as a combination of quadtree and multi-type tree partitioning (quadtree+multi-type tree partitioning) because of the addition of binary and/or ternary tree partitioning to quadtree partitioning.

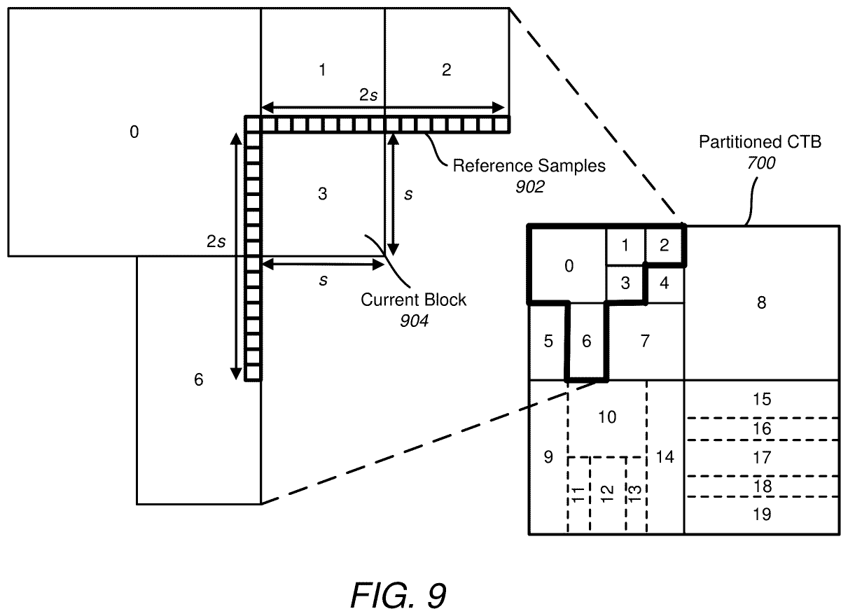

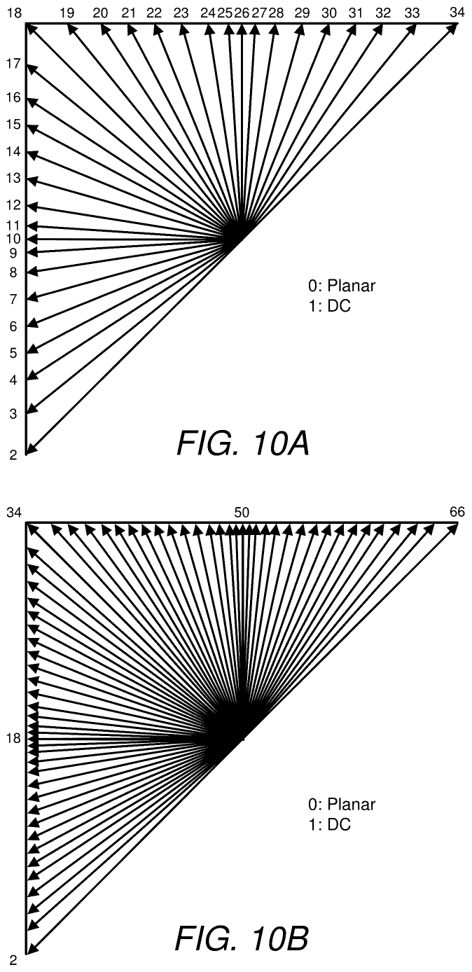

FIG. 7 shows an example of combined quadtree and multi-type tree partitioning of a CTB 700. FIG. 8 shows an example tree 800 corresponding to the combined quadtree and multi-type tree partitioning of CTB 700 shown in FIG. 7. In both FIGS. 7 and 8, quadtree splits are shown in solid lines and multi-type tree splits are shown in dashed lines. For ease of explanation, CTB 700 is shown with the same quadtree partitioning as the CTB 400 described in FIG. 4, and a description of the quadtree partitioning of CTB 700, which is similar to that for CTB 400, is omitted. The quadtree partitioning of the CTB 700 is merely an example and a CTB may be quadtree partitioned in a manner different from the CTB 700. Additional multi-type tree partitions of CTB 700 may be made relative to three leaf CBs shown in FIG. 4. The three leaf CBs in FIG. 4 that are shown in FIG. 7 as being further partitioned may be leaf CBs 5, 8, and 9. The three leaf CBs may be further partitioned using one or more binary and/or ternary tree partitions.

The leaf CB 5 of FIG. 4 may be partitioned into two CBs based on a vertical binary tree partitioning. The two resulting CBs may be leaf CBs respectively labeled 5 and 6 in FIGS. 7 and 8. The leaf CB 8 of FIG. 4 may be partitioned into three CBs based on a vertical ternary tree partition. Two of the three resulting CBs may be leaf CBS respectively labeled 9 and 14 in FIGS. 7 and 8. The remaining, non-leaf CB may be partitioned first into two CBs based on a horizontal binary tree partition. One of the two CBs may be a leaf CB labeled 10. The other of the two CBs may be further partitioned into three CBs based on a vertical ternary tree partition. The resulting three CBs may be leaf CBS respectively labeled 11, 12, and 13 in FIGS. 7 and 8. The leaf CB 9 of FIG. 4 may be partitioned into three CBs based on a horizontal ternary tree partition. Two of the three CBs may be leaf CBs respectively labeled 15 and 19 in FIGS. 7 and 8. The remaining, non-leaf CB may be partitioned into three CBs based on another horizontal ternary tree partition. The resulting three CBs may all be leaf CBs respectively labeled 16, 17, and 18 in FIGS. 7 and 8.

Altogether, CTB 700 may be partitioned into 20 leaf CBs respectively labeled 0-19. The 20 leaf CBs may correspond to 20 leaf nodes (e.g., 20 leaf nodes of tree 800 shown in FIG. 8). The resulting combination of quadtree and multi-type tree partitioning of the CTB 700 may be scanned using a z-scan (left-to-right, top-to-bottom) to form the sequence order for encoding/decoding the CB leaf nodes. A numeric label of each CB leaf node in FIGS. 7 and 8 may correspond to the sequence order for encoding/decoding, with CB leaf node 0 encoded/decoded first and CB leaf node 19 encoded/decoded last. Although not shown in FIGS. 7 and 8, it should be noted that each CB leaf node may comprise one or more PBs and/or TBs.

A coding standard/format (e.g., HEVC, VVC, or any other coding standard/format) may define various units (e.g., in addition to specifying various blocks (e.g., CTBs, CBs, PBs, TBs)). Blocks may comprise a rectangular area of samples in a sample array. Units may comprise the collocated blocks of samples from the different sample arrays (e.g., luma and chroma sample arrays) that form a picture as well as syntax elements and prediction data of the blocks. A coding tree unit (CTU) may comprise the collocated CTBs of the different sample arrays and may form a complete entity in an encoded bitstream. A coding unit (CU) may comprise the collocated CBs of the different sample arrays and syntax structures used to code the samples of the CBs. A prediction unit (PU) may comprise the collocated PBs of the different sample arrays and syntax elements used to predict the PBs. A transform unit (TU) may comprise TBs of the different samples arrays and syntax elements used to transform the TBs.

A block may refer to any of a CTB, CB, PB, TB, CTU, CU, PU, and/or TU (e.g., in the context of HEVC, VVC, or any other coding format/standard). A block may be used to refer to similar data structures in the context of any video coding format/standard/protocol. For example, a block may refer to a macroblock in the AVC standard, a macroblock or a sub-block in the VP8 coding format, a superblock or a sub-block in the VP9 coding format, and/or a superblock or a sub-block in the AV1 coding format.

In intra prediction, samples of a block to be encoded (e.g., also referred to as a current block) may be predicted from samples of the column immediately adjacent to the left-most column of the current block and samples of the row immediately adjacent to the top-most row of the current block. The samples from the immediately adjacent column and row may be jointly referred to as reference samples. Each sample of the current block may be predicted (e.g., in an intra prediction mode) by projecting the position of the sample in the current block in a given direction to a point along the reference samples. The sample may be predicted by interpolating between the two closest reference samples of the projection point if the projection does not fall directly on a reference sample. A prediction error (e.g., referred to as a residual) may be determined for the current block based on differences between the predicted sample values and the original sample values of the current block.

Predicting samples and determining a prediction error based on a difference between the predicted samples and original samples may be performed (e.g., at an encoder) for a plurality of different intra prediction modes (e.g., including non-directional intra prediction modes). The encoder may select one of the plurality of intra prediction modes and its corresponding prediction error to encode the current block. The encoder may send an indication of the selected prediction mode and its corresponding prediction error to a decoder for decoding of the current block. The decoder may decode the current block by predicting the samples of the current block, using the intra prediction mode indicated by the encoder, and/or combining the predicted samples with the prediction error.

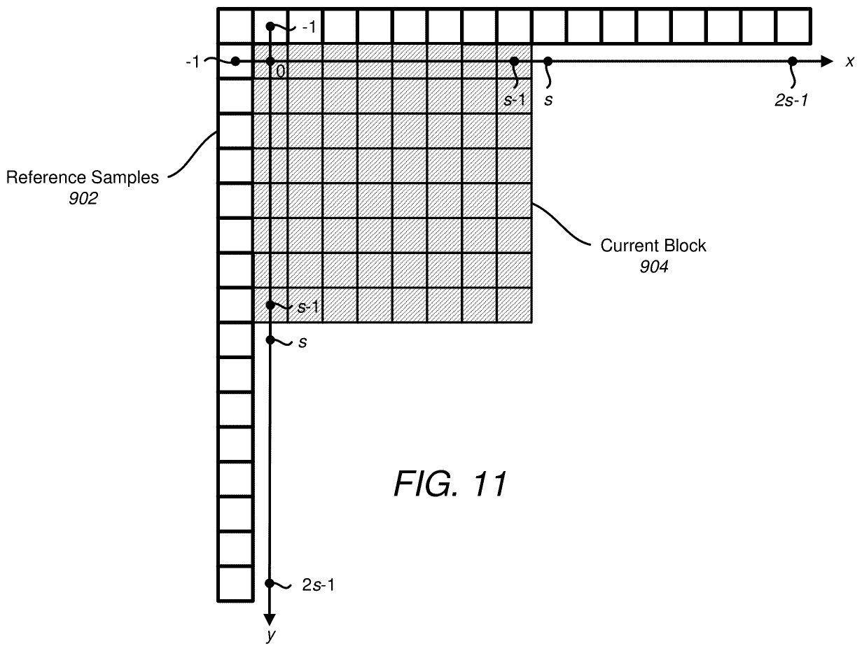

FIG. 9 shows an example set of reference samples 902 determined for intra prediction of a current block 904. Current block 904 may correspond to a block being encoded and/or decoded. Current block 904 may correspond to block 3 of partitioned CTB 700 as shown in FIG. 7. As described herein, the numeric labels 0-19 of the blocks of partitioned CTB 700 may correspond to the sequence order for encoding/decoding the blocks and may be used as such in the example of FIG. 9.

For current block 904 that is w×h samples in size, reference samples 902 may comprise: 2w samples (or any other quantity of samples) of the row immediately adjacent to the top-most row of current block 904, 2 h samples (or any other quantity of samples) of the column immediately adjacent to the left-most column of current block 904, and the top left neighboring corner sample to current block 904. Current block 904 may be square, such that w=h=s. In other examples, a current block need not be square, such that w≠h. Available samples from neighboring blocks of current block 904 may be used for constructing the set of reference samples 902. Samples may not be available for constructing the set of reference samples 902, for example, if the samples lie outside the picture of the current block, the samples are part of a different slice of the current block (e.g., if the concept of slices is used), and/or the samples belong to blocks that have been inter coded and constrained intra prediction is indicated. Intra prediction may not be dependent on inter predicted blocks, for example, if constrained intra prediction is indicated.

Samples that may not be available for constructing the set of reference samples 902 may comprise samples in blocks that have not already been encoded and reconstructed at an encoder and/or decoded at a decoder based on the sequence order for encoding/decoding. Restriction of such samples from inclusion in the set of reference samples 902 may allow identical prediction results to be determined at both the encoder and decoder. In the example of FIG. 9, samples from neighboring blocks 0, 1, and 2 may be available to construct reference samples 902 given that these blocks are encoded and reconstructed at an encoder and decoded at a decoder prior to coding of current block 904. The samples from neighboring blocks 0, 1, and 2 may be available to construct reference samples 902, for example, if there are no other issues (e.g., as mentioned above) preventing the availability of the samples from the neighboring blocks 0, 1, and 2. The portion of reference samples 902 from neighboring block 6 may not be available due to the sequence order for encoding/decoding (e.g., because the block 6 may not have already been encoded and reconstructed at the encoder and/or decoded at the decoder based on the sequence order for encoding/decoding).

In some examples, unavailable samples from reference samples 902 may be filled with one or more of the available reference samples 902. For example, an unavailable reference sample may be filled with a nearest available reference sample. The nearest available reference sample may be determined by moving in a clock-wise direction through reference samples 902 from the position of the unavailable reference. The reference samples 902 may be filled with the mid-value of the dynamic range of the picture being coded, for example, if no reference samples are available.

Reference samples 902 may be filtered based on the size of current block 904 being coded and an applied intra prediction mode. FIG. 9 shows an example determination of reference samples for intra prediction of a block. Reference samples may be determined in a different manner than described above. For example, multiple reference lines may be used in other instances (e.g., in VVC).

Samples of current block 904 may be intra predicted based on reference samples 902, for example, based on (e.g., after) determination and (optionally) filtering of reference samples 902. At least some (e.g., most) encoders/decoders may support a plurality of intra prediction modes in accordance with one or more video coding standards. For example, HEVC supports 35 intra prediction modes, including a planar mode, a direct current (DC) mode, and 33 angular modes. VVC supports 67 intra prediction modes, including a planar mode, a DC mode, and 65 angular modes. Planar and DC modes may be used to predict smooth and gradually changing regions of a picture. Angular modes may be used to predict directional structures in regions of a picture. Any quantity of intra prediction modes may be supported.

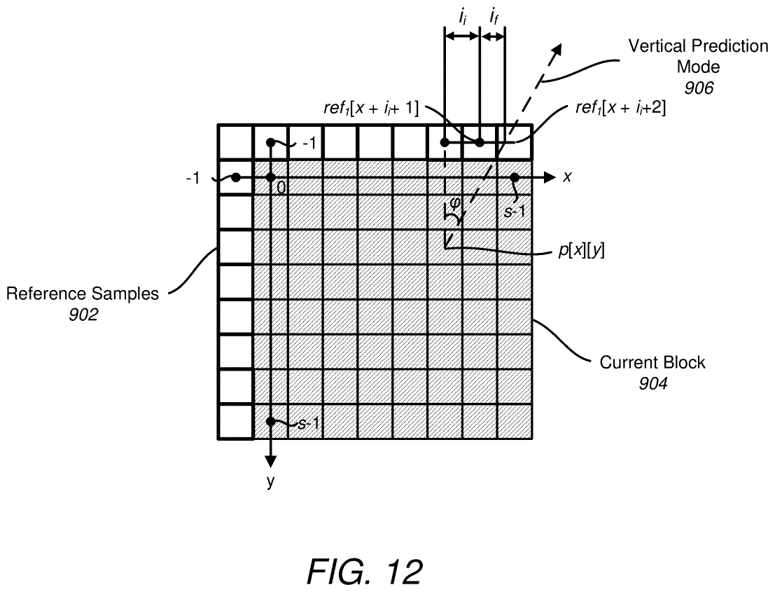

FIGS. 10A and 10B show example intra prediction modes. FIG. 10A shows 35 intra prediction modes, such as supported by HEVC. The 35 intra prediction modes may be indicated/identified by indices 0 to 34. Prediction mode 0 may correspond to planar mode. Prediction mode 1 may correspond to DC mode. Prediction modes 2-34 may correspond to angular modes. Prediction modes 2-18 may be referred to as horizontal prediction modes because the principal source of prediction is in the horizontal direction. Prediction modes 19-34 may be referred to as vertical prediction modes because the principal source of prediction is in the vertical direction.

FIG. 10B shows 67 intra prediction modes, such as supported by VVC. The 67 intra prediction modes may be indicated/identified by indices 0 to 66. Prediction mode 0 may correspond to planar mode. Prediction mode 1 corresponds to DC mode. Prediction modes 2-66 may correspond to angular modes. Prediction modes 2-34 may be referred to as horizontal prediction modes because the principal source of prediction is in the horizontal direction. Prediction modes 35-66 may be referred to as vertical prediction modes because the principal source of prediction is in the vertical direction. Some of the intra prediction modes illustrated in FIG. 10B may be adaptively replaced by wide-angle directions because blocks in VVC need not be squares.

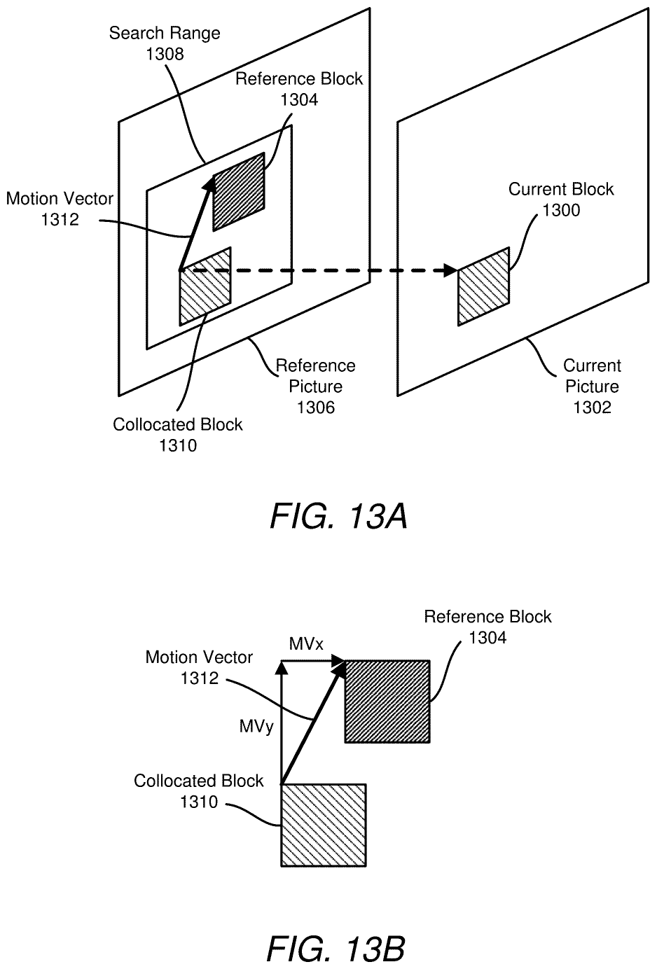

FIG. 11 shows a current block 904 and corresponding reference samples 902 from FIG. 9. To further describe how intra prediction modes are applied to determine a prediction (e.g., a prediction block) of current block 904, FIG. 11 shows current block 904 and reference samples 902 in a two-dimensional x, y plane, where a sample may be referenced as p[x][y]. To simplify the prediction process, reference samples 902 may be placed in two, one-dimensional arrays. The reference samples 902, above the current block 904, may be placed in the one-dimensional array ref₁[x]:

$${ref}_{1} [ x ] = p [ - 1 + x ] [ - 1 ] , ( x \geq 0 ) . \qquad ( 1 )$$

The reference samples 902 to the left of current block 904 may be placed in the one-dimensional array ref₂[y]:

$${ref}_{2} [ y ] = p [ - 1 ] [ - 1 + y ] , ( y \geq 0 ) . \qquad ( 2 )$$

The prediction process may comprise determination of a predicted sample p[x][y] (e.g., a predicted value) at a location [x][y] in current block 904. For planar mode, a sample at the location [x][y] in current block 904 may be predicted by determining/calculating the mean of two interpolated values. The first of the two interpolated values may be based on a horizontal linear interpolation at the location [x][y] in current block 904. The second of the two interpolated values may be based on a vertical linear interpolation at location [x][y] in current block 904. The predicted sample p[x][y] in current block 904 may be determined/calculated as:

$$p [ x ] [ y ] = \frac{1}{2 \cdot s} ( h [ x ] [ y ] + v [ x ] [ y ] + s ) , \qquad ( 3 )$$

$$where$$

$$h [ x ] [ y ] = ( s - x - 1 ) \cdot {ref}_{2} [ y ] + ( x + 1 ) \cdot {ref}_{1} [ s ] \qquad ( 4 )$$

may be the horizonal linear interpolation at the location [x][y] in current block 904 and

$$v [ x ] [ y ] = ( s - y - 1 ) \cdot {ref}_{1} [ x ] + ( y + 1 ) \cdot {ref}_{2} [ s ] \qquad ( 5 )$$

may be the vertical linear interpolation at the location [x][y] in current block 904. s may be equal to a length of a side (e.g., a number of samples on a side) of the current block 904.

For DC mode, a sample at a location [x][y] in current block 904 may be predicted by the mean of the reference samples 902. The predicted sample p[x][y] in current block 904 may be determined/calculated as:

$$p [ x ] [ y ] = \frac{1}{2 \cdot s} ( {\sum }_{x = 0}^{s - 1} {ref}_{1} [ x ] + {\sum }_{y = 0}^{s - 1} {ref}_{2} [ y ] ) . \qquad ( 6 )$$

For angular modes, a sample at a location [x][y] in current block 904 may be predicted by projecting the location [x][y] in a direction specified by a given angular mode to a point on the horizontal or vertical line of samples comprising reference samples 902. The sample at the location [x][y] may be predicted by interpolating between the two closest reference samples of the projection point if the projection does not fall directly on a reference sample. The direction specified by the angular mode may be given by an angle q defined relative to the y-axis for vertical prediction modes (e.g., modes 19-34 in HEVC and modes 35-66 in VVC). The direction specified by the angular mode may be given by an angle φ defined relative to the x-axis for horizontal prediction modes (e.g., modes 2-18 in HEVC and modes 2-34 in VVC).

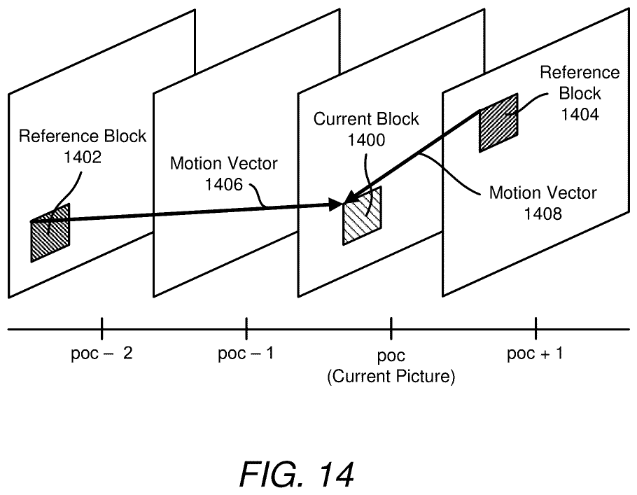

FIG. 12 shows an example applying an intra prediction mode (e.g., an angular mode such as vertical prediction mode 906) for prediction of a current block 904. FIG. 12 specifically shows prediction of a sample at a location [x][y] in current block 904 for a vertical prediction mode 906. Vertical prediction mode 906 may be given by an angle φ with respect to the vertical axis. The location [x][y] in current block 904, in vertical prediction modes, may be projected to a point (e.g., referred to as a projection point) on the horizontal line of reference samples ref₁[x]. The reference samples 902 are only partially shown in FIG. 12 for ease of illustration. As shown in FIG. 12, the projection point on the horizontal line of reference samples ref₁[x] may not be exactly on a reference sample. A predicted sample p[x][y] in current block 904 may be determined/calculated by linearly interpolating between the two reference samples, for example, if the projection point falls at a fractional sample position between two reference samples. The predicted sample p[x][y] may be determined/calculated as:

$$p [ x ] [ y ] = ( 1 - {i}_{f} ) \cdot {ref}_{1} [ x + {i}_{i} + 1 ] + {i}_{f} \cdot {ref}_{1} [ x + {i}_{i} + 2 ] . \qquad ( 7 )$$

iᵢ may be the integer part of the horizontal displacement of the projection point relative to the location [x][y]. iᵢ may be determined/calculated as a function of the tangent of the angle φ of the vertical prediction mode 906 as:

$${i}_{i} = ⌊ ( y + 1 ) \cdot tan φ ⌋ . \qquad ( 8 )$$

i_{f} may be the fractional part of the horizontal displacement of the projection point relative to the location [x][y] and may be determined/calculated as:

$${i}_{f} = ( ( y + 1 ) \cdot tan φ ) - ⌊ ( y + 1 ) \cdot tan φ ⌋ , \qquad ( 9 )$$

where └·┘ is the integer floor function.

For horizontal prediction modes, a location [x][y] of a sample in current block 904 may be projected onto the vertical line of reference samples ref₂[y]. A predicted sample p[x][y] for horizontal prediction modes may be determined/calculated as:

$$p [ x ] [ y ] = ( 1 - {i}_{f} ) \cdot {ref}_{2} [ y + {i}_{i} + 1 ] + {i}_{f} \cdot {ref}_{2} [ y + {i}_{i} + 2 ] . \qquad ( 10 )$$

iᵢ may be the integer part of the vertical displacement of the projection point relative to the location [x][y]. iᵢ may be determined/calculated as a function of the tangent of the angle φ of the horizontal prediction mode as:

$${i}_{i} = ⌊ ( x + 1 ) \cdot tan φ ⌋ . \qquad ( 11 )$$

i_{f} may be the fractional part of the vertical displacement of the projection point relative to the location [x][y]. i_{f} may be determined/calculated as:

$${i}_{f} = ( ( x + 1 ) \cdot tan φ ) - ⌊ ( x + 1 ) \cdot tan φ ⌋ , \qquad ( 12 )$$

where └·┘ is the integer floor function.

The interpolation functions given by Equations (7) and (10) may be implemented by an encoder and/or a decoder (e.g., encoder 200 in FIG. 2 and/or decoder 300 in FIG. 3). The interpolation functions may be implemented by finite impulse response (FIR) filters. For example, the interpolation functions may be implemented as a set of two-tap FIR filters. The coefficients of the two-tap FIR filters may be respectively given by (1−i_{f}) and i_{f}. The predicted sample p[x][y], in angular intra prediction, may be calculated with some predefined level of sample accuracy (e.g., 1/32 sample accuracy, or accuracy defined by any other metric). For 1/32 sample accuracy, the set of two-tap FIR interpolation filters may comprise up to 32 different two-tap FIR interpolation filters—one for each of the 32 possible values of the fractional part of the projected displacement i_{f}. In other examples, different levels of sample accuracy may be used.

In some examples, the FIR filters may be used for predicting chroma samples and/or luma samples. For example, the two-tap interpolation FIR filter may be used for predicting chroma samples and a same and/or a different interpolation technique/filter may be used for luma samples. For example, a four-tap FIR filter may be used to determine a predicted value of a luma sample. Coefficients of the four tap FIR filter may be determined based on i_{f} (e.g., similar to the two-tap FIR filter). For 1/32 sample accuracy, a set of 32 different four-tap FIR filters may comprise up to 32 different four-tap FIR filters—one for each of the 32 possible values of the fractional part of the projected displacement i_{f}. In other examples, different levels of sample accuracy may be used. The set of four-tap FIR filters may be stored in a look-up table (LUT) and referenced based on i_{f}. A predicted sample p[x][y], for vertical prediction modes, may be determined based on the four-tap FIR filter as:

$$p [ x ] [ y ] = {\sum }_{i = 0}^{3} fT [ i ] \cdot {ref}_{1} [ x + iIdx + i ] , \qquad ( 13 )$$

where fĪ[i], i=0 . . . 3, may be the filter coefficients, and Idx is integer displacement. A predicted sample p[x][y], for horizontal prediction modes, may be determined based on the four-tap FIR filter as:

$$p [ x ] [ y ] = {\sum }_{i = 0}^{3} fT [ i ] \cdot {ref}_{2} [ y + iIdx + i ] . \qquad ( 14 )$$

Supplementary reference samples may be determined/constructed if the location [x][y] of a sample in current block 904 to be predicted is projected to a negative x coordinate. The location [x][y] of a sample may be projected to a negative x coordinate, for example, if negative vertical prediction angles φ are used. The supplementary reference samples may be determined/constructed by projecting the reference samples in ref₂[y] in the vertical line of reference samples 902 to the horizontal line of reference samples 902 using the negative vertical prediction angle φ. Supplementary reference samples may be similarly determined/constructed, for example, if the location [x][y] of a sample in current block 904 to be predicted is projected to a negative y coordinate. The location [x][y] of a sample may be projected to a negative y coordinate, for example, if negative horizontal prediction angles φ are used. The supplementary reference samples may be determined/constructed by projecting the reference samples in ref₁[x] on the horizontal line of reference samples 902 to the vertical line of reference samples 902 using the negative horizontal prediction angle φ.

An encoder may determine/predict samples of a current block being encoded (e.g., current block 904) for a plurality of intra prediction modes (e.g., using one or more of the functions described herein). For example, an encoder may determine/predict samples of a current block for each of 35 intra prediction modes in HEVC and/or 67 intra prediction modes in VVC. The encoder may determine, for each intra prediction mode applied, a corresponding prediction error for the current block based on a difference (e.g., sum of squared differences (SSD), sum of absolute differences (SAD), or sum of absolute transformed differences (SATD) between the prediction samples determined for the intra prediction mode and the original samples of the current block. The encoder may determine/select one of the intra prediction modes to encode the current block based on the determined prediction errors. For example, the encoder may determine/select one of the intra prediction modes that results in the smallest prediction error for the current block. In some examples, the encoder may determine/select the intra prediction mode to encode the current block based on a rate-distortion measure (e.g., Lagrangian rate-distortion cost) determined using the prediction errors. The encoder may send an indication of the determined/selected intra prediction mode and its corresponding prediction error (e.g., residual) to a decoder for decoding of the current block.

A decoder may determine/predict samples of a current block being decoded (e.g., current block 904) for an intra prediction mode. For example, a decoder may receive an indication of an intra prediction mode (e.g., an angular intra prediction mode) from an encoder for a current block. The decoder may construct a set of reference samples and perform intra prediction based on the intra prediction mode indicated by the encoder for the current block in a similar manner (e.g., as described above for the encoder). The decoder may add predicted values of the samples (e.g., determined based on the intra prediction mode) of the current block to a residual of the current block to reconstruct the current block. In some examples, a decoder need not receive an indication of an angular intra prediction mode from an encoder for a current block. Instead, the decoder may determine an intra prediction mode through other, decoder-side means.

While various examples herein correspond to intra prediction modes in HEVC and VVC, the methods, devices, and systems as described herein may be applied to/used for other intra prediction modes (e.g., as used in other video coding standards/formats, such as VP8, VP9, AV1, etc.).

Intra prediction may exploit correlations between spatially neighboring samples in the same picture of a video sequence to perform video compression. Inter prediction is another coding tool that may be used to perform video compression. Inter prediction may exploit correlations in the time domain between blocks of samples in different pictures of a video sequence. For example, an object may be seen across multiple pictures of a video sequence. The object may move (e.g., by some translation and/or affine motion) or remain stationary across the multiple pictures. A current block of samples in a current picture being encoded may have/be associated with a corresponding block of samples in a previously decoded picture. The corresponding block of samples may accurately predict the current block of samples. The corresponding block of samples may be displaced from the current block of samples, for example, due to movement of the object, represented in both blocks, across the respective pictures of the blocks. The previously decoded picture may be a reference picture. The corresponding block of samples in the reference picture may be a reference block for motion compensated prediction. An encoder may use a block matching technique to estimate the displacement (or motion) of the object and/or to determine the reference block in the reference picture.

Similar to intra prediction, an encoder may determine a difference between a current block and a prediction for a current block. An encoder may determine a difference, for example, based on/after determining/generating a prediction for a current block (e.g., using inter prediction). The difference may be a prediction error (e.g., a residual). The encoder may store and/or send (e.g., signal), in/via a bitstream, the prediction error and/or other related prediction information. The prediction error and/or other related prediction information may be used for decoding and/or other forms of consumption. A decoder may decode the current block by predicting the samples of the current block (e.g., by using the related prediction information) and combining the predicted samples with the prediction error.

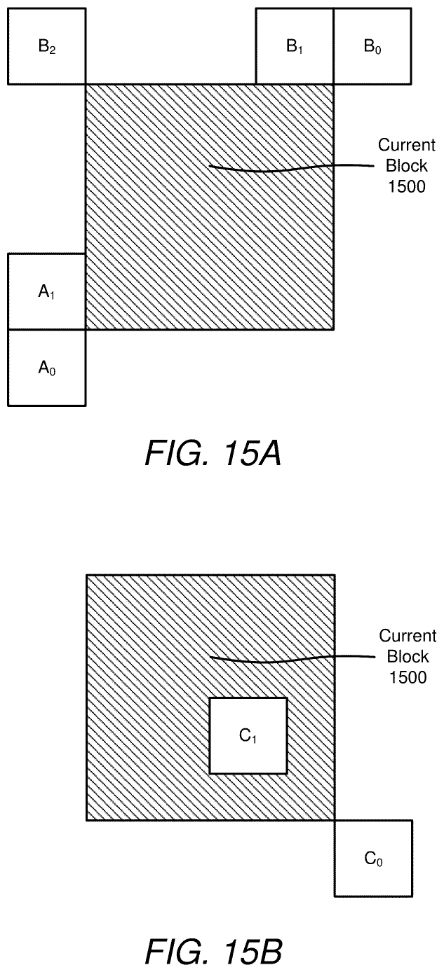

FIG. 13A shows an example of inter prediction. The inter prediction may be performed for a current block 1300 in a current picture 1302 being encoded. An encoder (e.g., encoder 200 as shown in FIG. 2) may perform inter prediction to determine and/or generate a reference block 1304 in a reference picture 1306. Reference block 1304 may be used to predict the current block 1300. Reference pictures (e.g., reference picture 1306) may be prior decoded pictures available at the encoder and/or a decoder. Availability of a prior decoded picture may depend/be based on whether the prior decoded picture is available in a decoded picture buffer, at the time, current block 1300 is being encoded and/or decoded. The encoder may search the one or more reference pictures 1306 for a block (e.g., a candidate reference block) that is similar (or substantially similar) to current block 1300. The encoder may determine the best matching block from the blocks (e.g., candidate reference blocks) tested during the searching process. The best matching block may be a reference block 1304. The encoder may determine that reference block 1304 is the best matching reference block based on one or more cost criteria. The one or more cost criteria may comprise a rate-distortion criterion (e.g., Lagrangian rate-distortion cost). The one or more cost criteria may be based on a difference (e.g., SSD, SAD, and/or SATD) between prediction samples of reference block 1304 and original samples of current block 1300.

The encoder may search for reference block 1304 within a reference region (e.g., a search range 1308). The reference region (e.g., a search range 1308) may be positioned around a collocated block (or position) 1310, of current block 1300, in reference picture 1306. Collocated block 1310 may have a same position in the reference picture 1306 as the current block 1300 in the current picture 1302. The reference region (e.g., search range 1308) may at least partially extend outside of reference picture 1306. Constant boundary extension may be used, for example, if the reference region (e.g., search range 1308) extends outside of reference picture 1306. The constant boundary extension may be used such that values of the samples in a row or a column of reference picture 1306, immediately adjacent to a portion of the reference region (e.g., search range 1308) extending outside of reference picture 1306, may be used for sample locations outside of reference picture 1306. A subset of potential positions, or all potential positions, within the reference region (e.g., search range 1308) may be searched for reference block 1304. The encoder may utilize one or more search implementations to determine and/or generate the reference block 1304. For example, the encoder may determine a set of candidate search positions based on motion information of neighboring blocks (e.g., a motion vector 1312) to the current block 1300.

One or more reference pictures may be searched by the encoder during inter prediction to determine and/or generate the best matching reference block. The reference pictures searched by the encoder may be included in (e.g., added to) one or more reference picture lists. For example, in HEVC and VVC (and/or in one or more other communication protocols), two reference picture lists may be used (e.g., a reference picture list 0 and a reference picture list 1). A reference picture list may include one or more pictures. The reference picture 1306 of reference block 1304 may be indicated by a reference index pointing into a reference picture list comprising reference picture 1306.

FIG. 13B shows an example motion vector. A displacement between reference block 1304 and current block 1300 may be interpreted as an estimate of the motion between reference block 1304 and current block 1300 across their respective pictures. The displacement may be represented by a motion vector 1312. For example, motion vector 1312 may be indicated by a horizontal component (MVx) and a vertical component (MVy) relative to the position of current block 1300. A motion vector (e.g., motion vector 1312) may have fractional or integer resolution. A motion vector with fractional resolution may point between two samples in a reference picture to provide a better estimation of the motion of current block 1300. For example, a motion vector may have ½, ¼, ⅛, 1/16, 1/32, or any other fractional sample resolution. Interpolation between the two samples at integer positions may be used to generate a reference block and its corresponding samples at fractional positions, for example, if a motion vector points to a non-integer sample value in the reference picture. The interpolation may be performed by a filter with two or more taps.

The encoder may determine a difference (e.g., a corresponding sample-by-sample difference) between reference block 1304 and current block 1300. The encoder may determine the difference between reference block 1304 and current block 1300, for example, based on/after reference block 1304 is determined and/or generated, using inter prediction, for current block 1300. The difference may be a prediction error (e.g., a residual). The encoder may store and/or send (e.g., signal), in/via a bitstream, the prediction error and/or related motion information. The prediction error and/or the related motion information may be used for decoding (e.g., decoding current block 1300) and/or other forms of consumption. The motion information may comprise the motion vector 1312 and a reference indicator/index. The reference indicator may indicate the reference picture 1306 in a reference picture list. In other examples, the motion information may comprise an indication of motion vector 1312 and/or an indication of the reference indicator/index. The reference indicator may indicate reference picture 1306 in the reference picture list comprising reference picture 1306. A decoder may decode current block 1300 by determining and/or generating the reference block 1304, which may correspond to/form (e.g., be considered as) a prediction of the current block 1300. The decoder may determine and/or generate the reference block 1304, for example, based on the related motion information. The decoder may decode current block 1300 based on combining the prediction (e.g., a reference block) with the prediction error (e.g., a residual block).

Inter prediction, as shown in FIG. 13A, may be performed using one reference picture 1306 as a source of a prediction for current block 1300. Inter prediction based on a prediction of a current block using a single picture may be referred to as uni-prediction.

Inter prediction of a current block, using bi-prediction, may be based on two pictures (e.g., the source of prediction may be from the two pictures). Bi-prediction may be useful, for example, if a video sequence comprises fast motion, camera panning, zooming, and/or scene changes. Bi-prediction also may be useful to capture fade outs of one scene or fade outs from one scene to another, where two pictures may effectively be displayed simultaneously with different levels of intensity.

One or both of uni-prediction and bi-prediction may be available/used for performing inter prediction (e.g., at an encoder and/or at a decoder). Performing a specific type of inter prediction (e.g., uni-prediction and/or bi-prediction) may depend on a slice type of current block. For example, for P slices, only uni-prediction may be available/used for performing inter prediction. For B slices, either uni-prediction or bi-prediction may be available/used for performing inter prediction. An encoder may determine and/or generate a reference block, for predicting a current block, from a reference picture list 0, for example, if the encoder is using uni-prediction. An encoder may determine and/or generate a first reference block, for predicting a current block, from a reference picture list 0 and determine and/or generate a second reference block, for predicting the current block, from a reference picture list 1, for example, if the encoder is using bi-prediction.

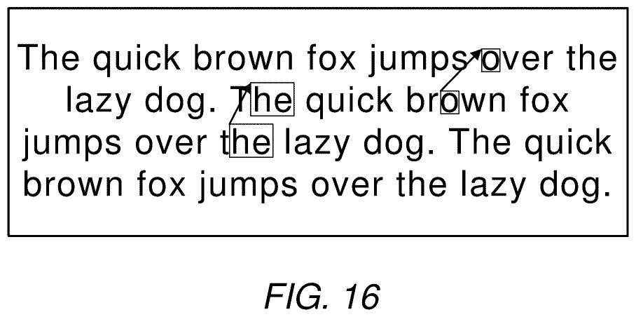

FIG. 14 shows an example of bi-prediction. Two reference blocks 1402 and 1404 may be used to predict a current block 1400. Reference block 1402 may be in a reference picture of one of reference picture list 0 or reference picture list 1. Reference block 1404 may be in a reference picture of another one of reference picture list 0 or reference picture list 1. As shown in FIG. 14, reference block 1402 may be in a first picture that precedes (e.g., in time) a current picture of current block 1400, and the reference block 1404 may be in a second picture that succeeds (e.g., in time) the current picture of current block 1400. The first picture may precede the current picture in terms of a picture order count (POC). The second picture may succeed the current picture in terms of the POC. In other examples, the reference pictures may both precede or both succeed the current picture in terms of POC. A POC may be/indicate an order in which pictures are output (e.g., from a decoded picture buffer). A POC may be/indicate an order in which pictures are generally intended to be displayed. Pictures that are output may not necessarily be displayed but may undergo different processing and/or consumption (e.g., transcoding). The two reference blocks determined and/or generated using/for bi-prediction may correspond to (e.g., be comprised in) a same reference picture. The reference picture may be included in both the reference picture list 0 and the reference picture list 1, for example, if the two reference blocks correspond to the same reference picture.

A configurable weight and/or offset value may be applied to one or more inter prediction reference blocks. An encoder may enable the use of weighted prediction using a flag in a picture parameter set (PPS). The encoder may send/signal the weight and/or offset parameters in a slice segment header for current block 1400. Different weight and/or offset parameters may be sent/signaled for luma and/or chroma components.

The encoder may determine and/or generate the reference blocks 1402 and 1404 for the current block 1400 using inter prediction. The encoder may determine a difference between current block 1400 and each of reference blocks 1402 and 1404. The differences may be prediction errors or residuals. The encoder may store and/or send/signal, in/via a bitstream, the prediction errors and/or their respective related motion information. The prediction errors and their respective related motion information may be used for decoding and/or other forms of consumption.

The motion information for reference block 1402 may comprise a motion vector 1406 and/or a reference indicator/index. The reference indicator may indicate a reference picture, of the reference block 1402, in a reference picture list. In some examples, the motion information for reference block 1402 may comprise an indication of motion vector 1406 and/or an indication of the reference index. The reference index may indicate the reference picture, of reference block 1402, in the reference picture list.

The motion information for reference block 1404 may comprise a motion vector 1408 and/or a reference index/indicator. The reference indicator may indicate a reference picture, of the reference block 1404, in a reference picture list. The motion information for reference block 1404 may comprise an indication of motion vector 1408 and/or an indication of the reference index. The reference index may indicate the reference picture, of the reference block 1404, in the reference picture list.

A decoder may decode current block 1400 by determining and/or generating the reference blocks 1402 and 1404. The decoder may determine and/or generate the reference blocks 1402 and 1404, for example, based on the respective related motion information for the reference blocks 1402 and 1404. The reference blocks 1402 and 1404 may correspond to/form (e.g., be considered as) the prediction (e.g., used to generate a prediction block) of the current block 1400. The decoder may decode the current block 1400 based on combining the prediction with the prediction errors.

Motion information may be predictively coded, for example, before being stored and/or sent/signaled in/via a bit stream (e.g., in HEVC, VVC, and/or other video coding standards/formats/protocols). The motion information for a current block may be predictively coded based on motion information of one or more blocks neighboring the current block. The motion information of the neighboring block(s) may often correlate with the motion information of the current block because the motion of an object represented in the current block is often the same as (or similar to) the motion of objects in the neighboring block(s). Motion information prediction techniques (such as those in HEVC and VVC) may comprise advanced motion vector prediction (AMVP) and/or inter prediction block merging (e.g., merge mode).

An encoder (e.g., encoder 200 as shown in FIG. 2), may code a motion vector. The encoder may code the motion vector (e.g., using AMVP) as a difference between a motion vector of a current block being coded and a motion vector predictor (MVP). An encoder may determine/select the MVP from a list of candidate MVPs. The candidate MVPs may be/correspond to previously decoded motion vectors of neighboring blocks in the current picture of the current block, and/or blocks at or near the collocated position of the current block in other reference pictures. The encoder and/or a decoder may reciprocally generate and/or determine the list of candidate MVPs.

The encoder may determine/select an MVP from the list of candidate MVPs. Then, the encoder may send/signal, in/via a bitstream, an indication of the selected MVP and/or a motion vector difference (MVD). The encoder may indicate the selected MVP in the bitstream using an index/indicator. The index may indicate the selected MVP in the list of candidate MVPs. The MVD may be determined/calculated based on a difference between the motion vector of the current block and the selected MVP. For example, for a motion vector (e.g., comprising a horizontal component (MVx) and a vertical component (MVy)) that indicates a position relative to a position of the current block being coded, the MVD may be represented by two components MVDₓ and MVD_{y}. MVDₓ and MVD_{y} may be determined/calculated as:

$${MVD}_{x} = {MV}_{x} - {MVP}_{x} , \qquad ( 15 )$$

$${MVD}_{y} = {MV}_{y} - {MVP}_{y} . \qquad ( 16 )$$

MVDx and MVDy may respectively represent horizontal and vertical components of the MVD. MVPx and MVPy may respectively represent horizontal and vertical components of the MVP.

A decoder (e.g., decoder 300 as shown in FIG. 3) may decode the motion vector by adding the MVD to the MVP indicated in/via the bitstream. The decoder may decode the current block by determining and/or generating the reference block. The decoder may determine and/or generate the reference block, for example, based on the decoded motion vector. The reference block may correspond to/form (e.g., be considered as) the prediction of the current block (e.g., a prediction block). The decoder may decode the current block by combining the prediction with the prediction error.

The list of candidate MVPs (e.g., in HEVC, VVC, and/or one or more other communication protocols), for AMVP, may comprise two or more candidates (e.g., candidates A and B). Candidates A and B may comprise: up to two (or any other quantity of) spatial candidate MVPs determined/derived from five (or any other quantity of) spatial neighboring blocks of a current block being coded; one (or any other quantity of) temporal candidate MVP determined/derived from two (or any other quantity of) temporal, co-located blocks (e.g., i_{f} both of the two spatial candidate MVPs are not available or are identical); and/or zero motion vector candidate MVPs (e.g., i_{f} one or both of the spatial candidate MVPs or temporal candidate MVPs are not available). Other quantities of spatial candidate MVPs, spatial neighboring blocks, temporal candidate MVPs, and/or temporal, co-located blocks may be used for the list of candidate MVPs.

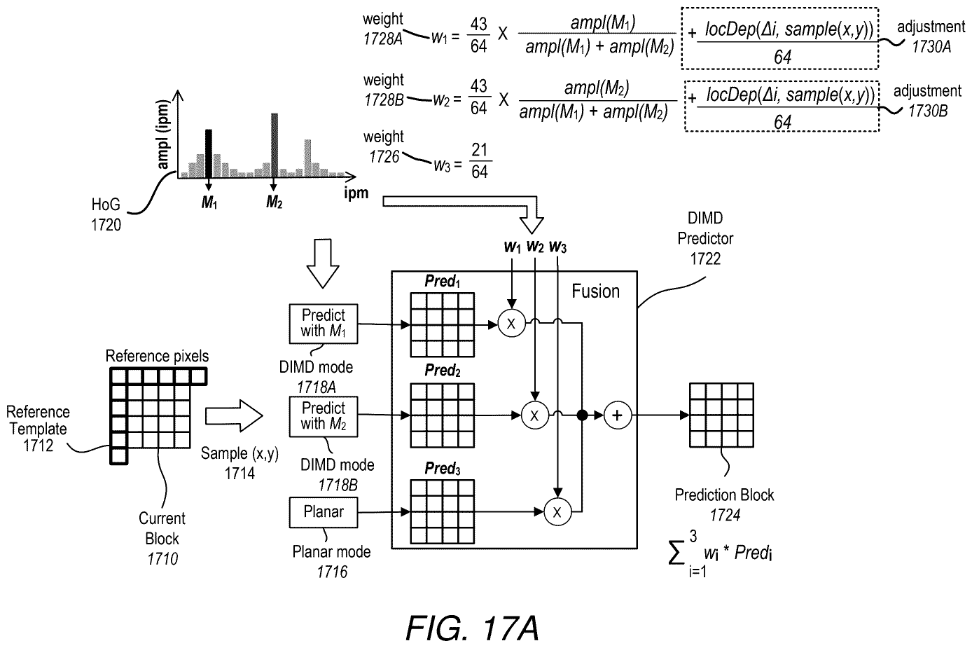

FIG. 15A shows example spatial candidate neighboring blocks for a current block. For example, five (or any other quantity of) spatial candidate neighboring blocks may be located relative to a current block 1500 being encoded. The five spatial candidate neighboring blocks may be A0, A1, B0, B1, and B2. FIG. 15B shows temporal, co-located blocks for the current block. For example, two (or any other quantity of) temporal, co-located blocks may be located relative to current block 1500 being coded. The two temporal, co-located blocks may be C0 and C1. The two temporal, co-located blocks may be in one or more reference pictures that may be different from the current picture of current block 1500.

An encoder (e.g., encoder 200 as shown in FIG. 2) may code a motion vector using inter prediction block merging (e.g., a merge mode). For example, the encoder (e.g., using merge mode) may reuse the same motion information of a neighboring block (e.g., one of neighboring blocks A0, A1, B0, B1, and B2) for inter prediction of a current block. For example, the encoder (e.g., using merge mode) may reuse the same motion information of a temporal, co-located block (e.g., one of temporal, co-located blocks C0 and C1) for inter prediction of a current block. An MVD need not be sent (e.g., indicated, signaled) for the current block because the same motion information as that of a neighboring block or a temporal, co-located block may be used for the current block (e.g., at the encoder and/or a decoder). A signaling overhead for sending/signaling the motion information of the current block may be reduced because the MVD need not be indicated for the current block. The encoder and/or the decoder may reciprocally generate a candidate list of motion information from neighboring blocks or temporal, co-located blocks of the current block (e.g., in a manner similar to AMVP). The encoder may determine to use (e.g., inherit) motion information, of one neighboring block or one temporal, co-located block in the candidate list, for predicting motion information of the current block being coded. The encoder may signal/send, in/via a bitstream, an indication of the determined motion information from the candidate list. For example, the encoder may signal/send an indicator/index. The index may indicate the determined motion information in the list of candidate motion information. The encoder may signal/send the index to indicate the determined motion information.

A list of candidate motion information for merge mode (e.g., in HEVC, VVC, or any other coding formats/standards/protocols) may comprise: up to four (or any other quantity of) spatial merge candidates derived/determined from five (or any other quantity of) spatial neighboring blocks (e.g., as shown in FIG. 15A); one (or any other quantity of) temporal merge candidate derived from two (or any other quantity of) temporal, co-located blocks (e.g., as shown in FIG. 15B); and/or additional merge candidates comprising bi-predictive candidates and zero motion vector candidates. In some examples, the spatial neighboring blocks and the temporal, co-located blocks used for merge mode may be the same as the spatial neighboring blocks and the temporal, co-located blocks used for AMVP.

Inter prediction may be performed in other ways and variants than those described herein. For example, motion information prediction techniques other than AMVP and merge mode may be used. While various examples herein correspond to inter prediction modes, such as used in HEVC and VVC, the methods, devices, and systems as described herein may be applied to/used for other inter prediction modes (e.g., as used for other video coding standards/formats such as VP8, VP9, AV1, etc.). History based motion vector prediction (HMVP), combined intra/inter prediction mode (CIIP), and/or merge mode with motion vector difference (MMVD) (e.g., as described in VVC) may be performed/used and are within the scope of the present disclosure.

A block matching operation (or technique) may be applied/used (e.g., in inter prediction) to determine a reference block in a different picture than that of a current block being coded (e.g., encoded and/or decoded). A block matching operation also may be applied/used to determine a reference block in a same picture as that of a current block being coded. The reference block, in a same picture as that of the current block, as determined using block matching may often not accurately predict the current block (e.g., for camera captured videos). Prediction accuracy for screen content videos may not be similarly impacted, for example, if a reference block in the same picture as that of the current block is used for encoding. Screen content videos may comprise, for example, computer generated text, graphics, animation, etc. Screen content videos may comprise (e.g., may often comprise) repeated patterns (e.g., repeated patterns of text and/or graphics) within the same picture. Using a reference block (e.g., as determined using block matching), in a same picture as that of a current block being encoded, may provide efficient compression for screen content videos.

A prediction technique may be used (e.g., in HEVC, VVC, and/or any other coding standards/formats/protocols) to exploit correlation between blocks of samples within a same picture (e.g., of screen content videos). The prediction technique may be intra block copy (IBC) or current picture referencing (CPR). An encoder may apply/use a block matching technique (e.g., similar to inter prediction) to determine a displacement vector (e.g., a block vector (BV)). The BV may indicate a relative position of a reference block (e.g., in accordance with intra block compensated prediction), that best matches the current block, from a position of the current block. For example, the relative position of the reference block may be a relative position of a top-left corner (or any other point/sample) of the reference block. The BV may indicate a relative displacement from the current block to the reference block that best matches the current block. The encoder may determine the best matching reference block from blocks tested during a searching process (e.g., in a manner similar to that used for inter prediction). The encoder may determine that a reference block is the best matching reference block based on one or more cost criteria. The one or more cost criteria may comprise a rate-distortion criterion (e.g., Lagrangian rate-distortion cost). The one or more cost criteria may be based on, for example, one or more differences (e.g., an SSD, an SAD, an SATD, and/or a difference determined based on a hash function) between the prediction samples of the reference block and the original samples of the current block. A reference block may correspond to/comprise prior decoded blocks of samples (e.g., reconstructed samples) of the current picture. The reference block may comprise decoded blocks of samples of the current picture prior to being processed by in-loop filtering operations (e.g., deblocking and/or SAO filtering).

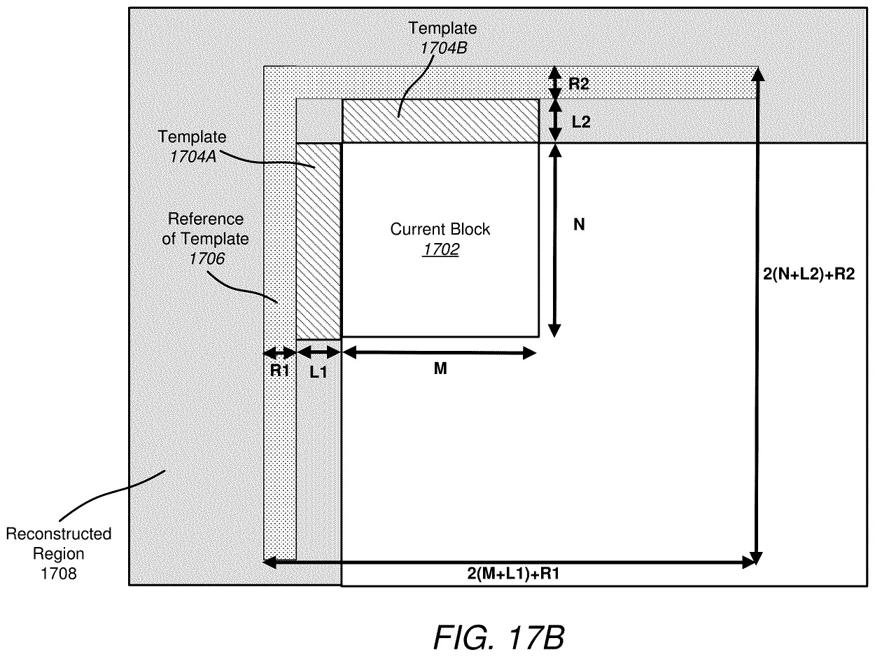

FIG. 16 shows an example of IBC (e.g., an IBC mode). The example shown in FIG. 16 may correspond to screen content. The rectangular portions/sections with arrows beginning at their boundaries may be the current blocks being encoded. The rectangular portions/sections that the arrows point to may be the reference blocks for predicting the respective current blocks.

A reference block may be determined and/or generated, for a current block, using IBC. The encoder may determine a difference (e.g., a corresponding sample-by-sample difference) between the reference block and the current block. The difference may be a prediction error or residual. The encoder may store and/or send/signal, in/via a bitstream the prediction error and/or related prediction information. The prediction error and/or the related prediction information may be used for decoding and/or other forms of consumption. The prediction information may comprise a BV. The prediction information may comprise an indication of the BV. A decoder (e.g., decoder 300 as shown in FIG. 3), may decode the current block by determining and/or generating the reference block. The decoder may determine and/or generate the current block, for example, based on the prediction information (e.g., the BV). The reference block may correspond to/form (e.g., be considered as) the prediction (e.g., a prediction block) of the current block. The decoder may decode the current block by combining the prediction (e.g., prediction block) with the prediction error (e.g., residual or residual block).

A BV may be predictively coded (e.g., in HEVC, VVC, and/or any other coding standards/formats/protocols) before being stored and/or sent/signaled in/via a bitstream. For example, the BV for a current block may be predictively coded based on a BV of one or more blocks neighboring the current block. For example, an encoder may predictively code a BV using the merge mode (e.g., in a manner similar to as described herein for inter prediction), AMVP (e.g., as described herein for inter prediction), or a technique similar to AMVP. The technique similar to AMVP may be BV prediction and difference coding (or AMVP for IBC).

An encoder (e.g., encoder 200 as shown in FIG. 2) performing BV prediction and coding may code a BV as a difference between the BV of a current block being coded and a block vector predictor (BVP). An encoder may select/determine the BVP from a list of candidate BVPs. The candidate BVPs may comprise/correspond to previously decoded BVs of neighboring blocks in the current picture of the current block. The encoder and/or a decoder may reciprocally generate or determine the list of candidate BVPs.

The encoder may send/signal, in/via a bitstream, an indication of the selected BVP and a block vector difference (BVD). The encoder may indicate the selected BVP in the bitstream using an index/indicator. The index may indicate (e.g., point to) the selected BVP in the list of candidate BVPs. The BVD may be determined/calculated based on a difference between a BV of the current block and the selected BVP. For example, for a BV (e.g., represented by a horizontal component (BVx) and a vertical component (BVy) that indicates a position relative to a position of the current block being coded, the BVD may be represented by two components BVDx and BVDy. BVDx and BVDy may be determined/calculated as:

$${BVD}_{x} = {BV}_{x} - {BVP}_{x} , \qquad ( 17 )$$

$${BVD}_{y} = {BV}_{y} - {BVP}_{y} . \qquad ( 18 )$$

BVDx and BVDy may respectively represent horizontal and vertical components of the BVD. BVPx and BVPy may respectively represent horizontal and vertical components of the BVP. A decoder (e.g., decoder 300 as shown in FIG. 3), may decode the BV by adding the BVD to the BVP indicated in/via the bitstream. The decoder may decode the current block by determining and/or generating the reference block. The decoder may determine and/or generate the reference block, for example, based on the decoded BV. The reference block may correspond to/form (e.g., be considered as) the prediction (e.g., a prediction block) of the current block. The decoder may decode the current block by combining the prediction (e.g., the prediction block) with the prediction error (e.g., residual or residual block).

A same BV as that of a neighboring block may be used for the current block and a BVD need not be separately signaled/sent for the current block, such as in the merge mode. A BVP (in the candidate BVPs), which may correspond to a decoded BV of the neighboring block, may itself be used as a BV for the current block. Not sending the BVD may reduce the signaling overhead.

A list of candidate BVPs (e.g., in HEVC, VVC, and/or any other coding standard/format/protocol) may comprise two (or more) candidates. The candidates may comprise candidates A and B. Candidates A and B may comprise: up to two (or any other quantity of) spatial candidate BVPs determined/derived from five (or any other quantity of) spatial neighboring blocks of a current block being encoded; and/or one or more of last two (or any other quantity of) coded BVs (e.g., if spatial neighboring candidates are not available). Spatial neighboring candidates may not be available, for example, if neighboring blocks are encoded using intra prediction or inter prediction. Locations of the spatial candidate neighboring blocks, relative to a current block, being encoded using IBC may be illustrated in a manner similar to spatial candidate neighboring blocks used for coding motion vectors in inter prediction (e.g., as shown in FIG. 15A). For example, five spatial candidate neighboring blocks of a current block being coded using IBC may be respectively denoted A0, A1, B0, B1, and B2 as shown in FIG. 15A.

In existing technologies, various decoder-side technique were introduced by which intra prediction of a current block may be performed to determine a prediction block for reconstructing the current block without a need for explicit signaling of any specific intra prediction mode(s) in the bitstream. Such techniques are enabled based on the encoder and decoder using previously encoded/decoded samples (e.g., reconstructed samples) reciprocally (e.g., independently and identically) deriving an intra mode for coding the current block. Signaling of the intra mode can be omitted if the encoder and decoder reciprocally determines/derives the same intra mode. These decoder-side techniques include decoder-side intra mode derivation (DIMD) and template-based intra mode derivation (TIMD).

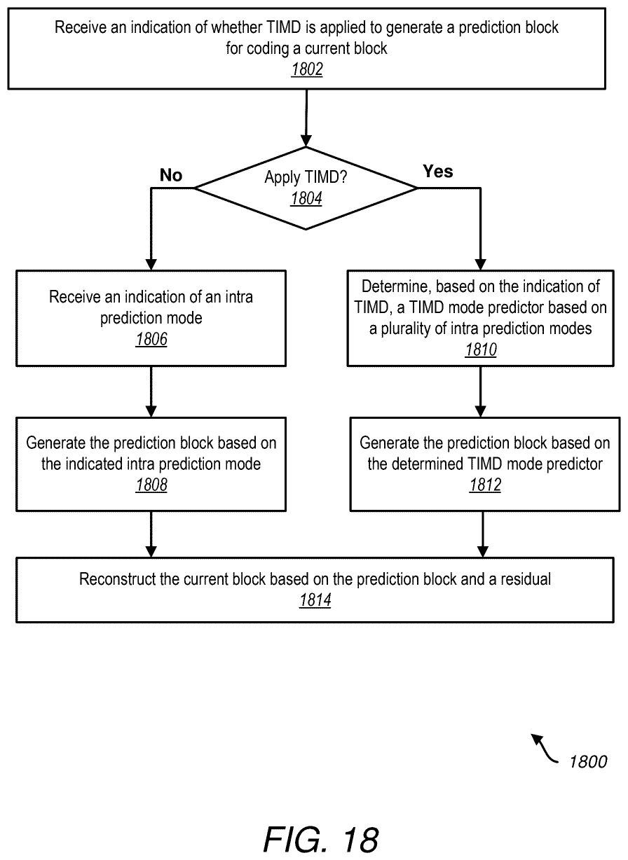

FIG. 17A shows an example of decoder-side intra mode derivation (DIMD) for coding a current block, according to some embodiments. The DIMD method performs a texture gradient processing to derive a number (e.g., 2) of DIMD modes. In some examples, a fusion/blending scheme may be applied for DIMD such that a DIMD predictor 1722 may comprise a combination (e.g., fusion or blending) of DIMD modes 1716 and 1718A-B. For example, DIMD modes 1718A and 1718B may be the best modes (e.g., lowest costs) and combined with DIMD mode 1716 which may be a planar mode. DIMD predictor 1722 may comprise a weighted average (e.g., a linear combination) with weights 1728A-B and 1726 determined for DIMD modes 1718A-B and 1716, respectively. DIMD predictor 1722 may be applied to reference template 1712 (e.g., current template) to determine a prediction block 1724 for current block 1710. The selection of DIMD is signaled in the bitstream for intra coded blocks using a flag. At the decoder, if the DIMD flag is true, the intra prediction mode(s) are derived in the reconstruction process using the same previously encoded neighboring pixels. If not, the intra prediction mode is parsed from the bitstream as in classical intra coding mode.

In some examples, to derive the DIMD modes (and DIMD predictor 1722) for current block 1710, reference template 1712 may be determined and a set of reference samples (e.g., neighboring pixels) may be selected on which to perform a gradient analysis such as that described above in FIGS. 11-12. For normativity purposes, these pixels should be decoded/reconstructed pixels of the picture. A main angular direction (corresponding to an IPM) for the template (e.g., reference template 1712) may be determined and assumed to have a high chance to be identical to the one of the current block that is to be predicted. In some examples, the gradient analysis may be performed using a simple 3×3 Sobel gradient filter, defined by the following matrices that will be convoluted with the template:

$${M}_{hor} = [ \begin{matrix}- 1 & 0 & 1 \\ - 2 & 0 & 2 \\ - 1 & 0 & 1\end{matrix} ] and {M}_{ver} = [ \begin{matrix}- 1 & - 2 & - 1 \\ 0 & 0 & 0 \\ 1 & 2 & 1\end{matrix} ]$$

For each of selected reference samples (e.g., pixels) of template 1712, point-by-point multiply of each of these two matrices with a 3×3 Sobel filter window may be performed and the results are summed. The 3×3 Sobel filter window may be centered around the current reference sample and composed of its 8 direct neighbors. Thus, two values Gₓ (from the multiplication with Mₕₒᵣ), and G_{y} (from the multiplication with Mᵥₑᵣ) are obtained corresponding to the gradient intensities at the current sample, in the horizontal and vertical direction, respectively. An angle may be calculated for the window as angle=arctan (Gₓ/G_{y}). The calculated angle may correspond to (e.g., be converted into) one of the angular IPMs (e.g., one of the 65 angular IPMs), and an associated amplitude (i.e., the amplitude for the window position) amplitude=|G_{y}+|Gₓ| may be added to a histogram of gradients (HoG) 1720 indexed by the respective IPM. After an amplitude and angle for each window position in template 1712 are processed, each entry in resulting HoG 1720 represents the cumulated amplitudes for a respective IPM. Accordingly, HoG 1720 may be determined with amplitudes corresponding to counts of IPMs across the gradient analysis performed for each sample of reference template 1712.

In some examples, a plurality of IPMs such as DIMD modes 1718A-B may be determined for the blending/fusion process. In some examples, a planar mode may have a fixed weight (e.g., ¼) and the remaining weights may be adjusted based on one minus the fixed weight (e.g., 1−¼=¾).

In some examples, a location-dependent DIMD mode is introduced as to adjust weights 1728A-B of angular IPMs in DIMD. During DIMD IPM derivation, a process referred to as “location-dependency” determination is applied to determine which template region each of the selected directional modes comes from. To determine whether specific reference samples in the template contribute to inferring specific DIMD modes, three separate regions are considered within the DIMD template-including a region above the current block (ABOVE), a region to the left of current block (LEFT), and an above-left region of current block (ABOVE-LEFT). For example, the left region may include one or more columns of samples to the left of the current block. For example, the above region may include one or more rows of samples above the current block. For example, the above-left region may include one or more samples that are both above and to the left of the current block. The gradient computation is performed separately for samples in each region, resulting in three histograms, H_{above}, H_{left} and H_{aboveLeft}, respectively. For example, for a directional mode m, H_{above} [m] represents the cumulative magnitude of all samples in the region ABOVE at direction m and H_{left} [m] and H_{aboveLeft} [m] similarly correspond to the LEFT region and the ABOVE-LEFT region. It should be noticed that the template area may be extended by one sample on the top-left and one sample on the bottom-right, with respect to conventional DIMD.

The full histogram of gradients for the whole template can then be computed as the sum of the three separate histograms. As in conventional DIMD, the two directional modes with largest and second-largest cumulative magnitude in the histogram are selected as main and secondary DIMD modes, dimdMode₀ and dimdMode₁, respectively.

Additionally, the histograms H_{above} and H_{left} can be used to determine whether dimdMode₀ and/or dimdMode₁ depend on a specific template region ABOVE or LEFT. In particular, the indication of location-dependency of dimdModeᵢ, denoted as indication locDepᵢ, can be defined as:

```
  If : (H_{above} [dimdModeᵢ] > 2H_{left} [dimdModeᵢ]), then:
    locDepᵢ = 1, that is dimdModeᵢ depends on region ABOVE.
Else if : (H_{left} [dimdModeᵢ] > 2H_{above} [dimdModeᵢ]), then:
      locDepᵢ = 2, that is dimdModeᵢ depends on region LEFT.
        Else:
      locDepᵢ = 0, that is dimdModeᵢ is not location-dependent.
```

Thus location-dependency in DIMD for each DIMD mode may be determined based on the analysis of HoG peaks amplitudes of the selected angular IPM corresponding to the DIMD mode.

In some embodiments, the fusion/blending scheme by which DIMD predictor 1722 is determined may be adjusted based on the location-dependent DIMD modes. For example, blending is performed to fuse the main and secondary DIMD predictors, dimdPred₀ and dimdPred₁, with the Planar predictor dimdPlanar. In case no DIMD mode is determined to be location-dependent (e.g., meaning indications locDep₀==locDep₁==0) then uniform blending is applied. Uniform weights wDimd₀, wDimd₁, and wPlanar are derived based on the relative magnitudes of the modes in the histogram, and the final DIMD prediction may be computed as:

$$fusionPred ( x , y ) = ( {\sum }_{i = 0}^{1} \{ {wDimd}_{i} * {dimdPred}_{i} ( x , y ) \} + wPlanar * dimdPlanar ( x , y ) ) ≫ 6.$$

Otherwise, if at least one of the DIMD modes is inferred to be location-dependent, e.g., the indication of location dependency is not zero, then sample-based blending is used. A different weight is used to blend the predictors at each location (x, y).

If locDepᵢ≠0 (e.g., indication of location dependency indicates a vertical or horizontal direction) the sample-based weights wLocDepDimdᵢ(x, y) for predictor dimdPredᵢ are computed so that the average weight used within the block is approximately equal to the uniform weight wDimdᵢ and so that higher weights are used in the portion of the block closer to the region ABOVE or LEFT, depending on locDepᵢ. A fixed range Δᵢ may be determined and is predefined, (e.g., typically Δᵢ=10) corresponding to the largest deviation of wLocDepDimdᵢ(x, y) from wDimdᵢ. Higher values of Δᵢ result in a higher variation of the weights within the block. In particular for a block of size H×W:

$$If {locDep}_{i} = 1 , then :$$

$${wLocDepDimd}_{i} ( x , y ) = {wDimd}_{i} + {Δ}_{i} - 2 {Δ}_{i} \frac{y}{( H - 1 )}$$

$$Else if {locDep}_{i} = 2 , then :$$

$${wLocDepDimd}_{i} ( x , y ) = {wDimd}_{i} + {Δ}_{i} - 2 {Δ}_{i} \frac{x}{( W - 1 )}$$

If both locDepᵢ≠0, i=0, 1, then the weights wLocDepDimdᵢ(x, y) are computed for both predictors as shown above, depending on the value of locDepᵢ.

Conversely, if locDepᵢ=0 and locDep₍₁₋ᵢ₎≠0, then the weights for wLocDepDimdᵢ(x, y) are computed as follows:

$${wLocDepDimd}_{i} ( x , y ) = {wDimd}_{i} - \frac{{wLocDepDimd}_{( 1 - i )} ( x , y ) - {wDimd}_{( 1 - i )}}{2}$$

Finally, the weights for the Planar predictor wLocDepPlanar(x, y) are then computed as:

$$wLocDepPlanar ( x , y ) = 64 - {\sum }_{i = 0}^{1} \{ {wLocDepDimd}_{i} ( x , y ) \}$$

The final location-dependent DIMD prediction is then computed as:

$$fusionPred ( x , y ) = ( \begin{matrix}{\sum }_{i = 0}^{1} \{ {wLocDepDimd}_{i} ( x , y ) * {dimdPred}_{i} ( x , y ) \} + \\ wLocDepPlanar ( x , y ) * dimdPlanar ( x , y ) + 32\end{matrix} ) ≫ 6$$

Eventually, the planar mode may be systematically applied in the blending process with a fixed weight (e.g., ¼ or 21/64).

FIG. 17B shows an example of template-based intra mode derivation (TIMD) for coding a current block, according to some embodiments. TIMD is a type of intra prediction in which an intra prediction mode (IPM) may be reciprocally determined (e.g., identically and independently derived) by an encoder (e.g., encoder 200) and a decoder (e.g., decoder 300) such that the IPM determined (e.g., selected) by the encoder does not need to be signaled to the decoder. Hence signaling bandwidth is reduced and TIMD may be considered as a type of decoder-side intra mode derivation process.

As shown in FIG. 17B, for TIMD, a video coder (e.g., encoder 200 or decoder 300) may determine a template 1704 for current block 1702. Template 1704 may comprise one or more regions of samples in a reconstructed region 1708 of a current picture (or frame) of current block 1702. The one or more regions may include reconstructed samples neighboring (e.g., adjacent to) current block 1702. In some examples, the one or more regions of template 1704 may comprise a template region 1704A to the left of current block 1702 (e.g., a left template) and a template region 1704B above current block 1702 (e.g., an above template). In some examples, template 1704 may include a region that is above and to the left of current block 1702 (e.g., the region enclosed by reference of template 1706 and template regions 1704A-B and referred to as above-left template). Template regions 1704A and 1704B may have a thickness (e.g., width and height respectively) of R1 and R2 samples, respectively. For example, R1 and/or R2 may be 2 samples, 4 samples, 8 samples, etc. Template region 1704A may have a height of N samples, which may be a height of current block 1702. Template region 1704B may have a width of M samples, which may be a width of current block 1702. Accordingly, template 1704A may include a number L1 of columns of reconstructed samples to the left (e.g., adjacent to) of current block 1702. Similarly, template 1704B may include a number L2 of rows of reconstructed samples above (e.g., adjacent to) current block 1702.

In TIMD, reference of template 1706 is used to derive a template predictor for predicting template 1704. The video coder may determine (e.g., select and obtain) reference of template 1706 as a region of samples (in reconstructed region 1708) neighboring (e.g., adjacent to) template 1704. For example, reference of template 1706 may comprise reconstructed samples left and above template 1704. Reference of template 1706 may have a thickness to the left of template region 1704A of R1 samples and a thickness above template region 1704B of R2 samples. For example, R1 and/or R2 may be 1 sample, 2 samples, 4 samples, etc. and R1 may be different from R2. Accordingly, reference of template 1706 may include a number R1 of columns of reconstructed samples to the left of template 1704A and a number R2 of rows of reconstructed samples above template 1704A. In some examples, reference of template 1706 may include an upper region having a width greater than template region 1704B (e.g., a width that is greater or equal to twice the width of template region 1704B, 2(M+L1) samples, 2(M+L1)+R1 samples, etc.). In some examples, reference of template 1706 may include a left region having a height greater than template region 1704A (e.g., a height that is greater or equal to twice the height of template region 1704A, 2(N+L1) samples, 2(N+L1)+R2 samples, etc.).

In some examples, a TIMD mode predictor may be determined using a list of candidate intra prediction modes (IPMs). For example, the list may include IPMs from a most probable mode (MPM) list. In some examples, one or more of a DC mode, a planar mode, a horizontal and/or vertical DC mode, or a horizontal and/or vertical planar, may be added to the list of candidate IPMs. A cost (e.g., SSE, SAD, or SATD, etc.) for each candidate IPM in the list may be determined based on differences between reconstructed samples in template 1704 and predicted samples of template 1704 generated based on reference of template 1706 and using the candidate IPM. For example, the video coder may determine the predicted samples of template 1704 by applying the candidate IPM to samples of reference of template 1706 similar to how an intra prediction mode may be applied to template 1704 to predict current block 1702 in regular intra prediction.

In some examples, a first IPM and a second IPM, from the list, with the lowest costs of costs (determined for candidate IPMs in the list) are selected to determine (e.g., derive) a first TIMD mode and a second TIMD mode. In an example, the first and second TIMD modes are determined as the first and second IPMs, respectively.

In some examples, the first and second TIMD modes may be determined by refining the first and second IPMs. For example, an angular mode range may be extended from a first range of the list (e.g., 67 modes) to a second range (e.g., 131 modes) and costs of the two adjacent modes (i.e., +/−1 mode) of each selected IPM may be determined. For example, the first TIMD mode may be determined as an IPM having the smallest cost among costs of the first IPM and its two adjacent modes in the second range. The second TIMD mode may be determined as an IPM having the smallest cost among costs of the second IPM and its two adjacent modes in the second range.

In some embodiments, a TIMD mode predictor may be determined based on combining (e.g., blending or fusing) the first TIMD mode and the second TIMD mode. For example, the TIMD mode predictor may be a linear combination of the first TIMD mode and the second TIMD mode. Each weight of the first and second TIMD modes, in the linear combination, may be determined based on costs of the first and second TIMD modes, respectively. For example, a weight, for a TIMD mode of the first and second TIMD modes, may be determined as being inversely proportional to a cost of the TIMD mode. The TIMD mode predictor may be applied to template 1704 to determine a prediction block for predicting current block 1702. An encoder may generate a residual (e.g., prediction error) based on a difference between the prediction block and current block 1702. A decoder may reconstruct current block 1702 based on the reciprocally/identically generated prediction block and the residual received from the encoder in a bitstream. For example, the decoder may combine/add the residual obtained from the bitstream with the prediction block.

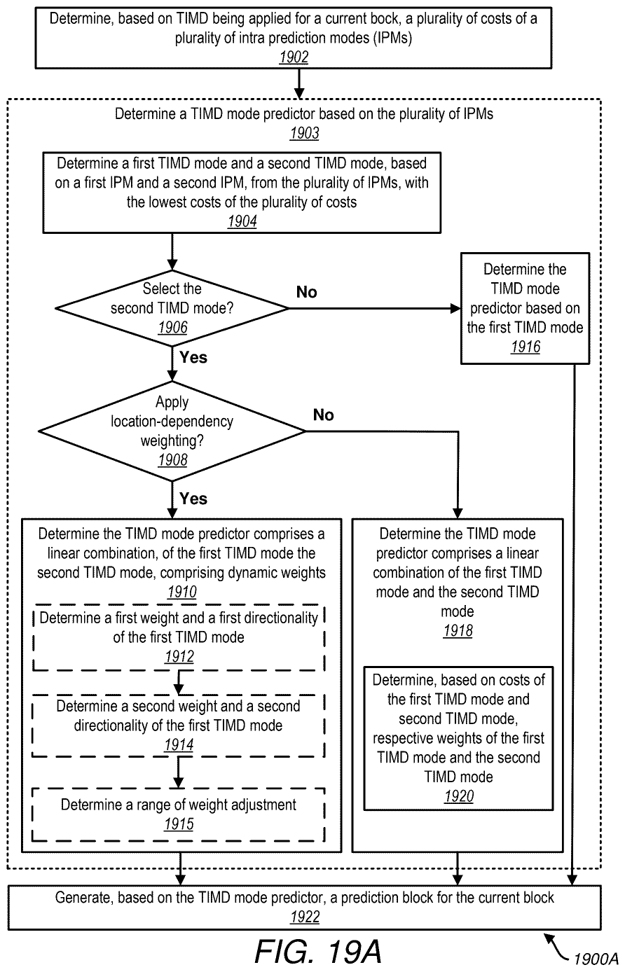

FIG. 18 shows an example of signaling TIMD for decoding a current block, according to some embodiments. At block 1802, a decoder receives (e.g., from a bitstream) an indication of whether TIMD is applied to generate a prediction block for coding a current block. As explained above, TIMD is a type of intra prediction in which a template, of the current block, in the reconstructed region of the picture is used to derive an intra prediction mode for coding the current block. For example, the indication may be a flag that indicates whether TIMD is enabled (e.g., applied). For example, the flag may be a single bit.

At block 1804, the decoder determines whether to apply TIMD based on the indication received at block 1802.

At block 1810, based on the indication of TIMD being applied (e.g., enabled or being selected), the decoder determines (e.g., derives) a TIMD mode predictor based on a plurality of intra prediction modes (IPMs), e.g., without additional signaling from an encoder indicating a specific intra prediction mode. As described above in FIG. 17B, the TIMD mode predictor may be determined based on determining two IPMs, from the plurality of IPMs, having the lowest costs of costs determined for the plurality of IPMs. Because the encoder and decoder reciprocally (e.g., independently and identically) determines the TIMD mode predictor, signaling of any specific intra prediction mode (IPM) may be omitted from the bitstream. At block 1812, the decoder generates a prediction block based on the determined TIMD mode predictor (e.g., as described in FIG. 17B).

At block 1806, based on the indication of TIMD not being applied (e.g., disabled or not being selected), the decoder receives (e.g., parses) an indication of an intra prediction mode (IPM) from the bitstream. The indication may comprise a plurality of bits representing an index specifying the IPM from a list of IPMs (e.g., an MPM list). At block 1808, the decoder generates a prediction block based on the indicated IPM (e.g., as described in FIG. 17B). At block 1814, the decoder reconstructs the current block based on the prediction block and a residual, e.g., received from a bitstream.

In existing technologies, TIMD was introduced as a decoder-side technique in which intra prediction of a current block may be performed to determine a prediction block for reconstructing the current block without a need for explicit signaling of any specific intra prediction modes in the bitstream. Further, a TIMD mode predictor may be generated as a linear combination of two or more intra prediction modes (IPMs), from a list of IPMs, having the lowest costs (e.g., SATD or SAD) of costs of the IPMs in the list. The list of IPMs may include one or more angular IPMs, a DC mode, and/or one or more planar modes (e.g., a vertical planar mode or a horizontal planar mode). The linear combination of multiple IPMs is also referred to as TIMD IPM fusion or TIMD IPM blending.

In general, the TIMD modes are selected as minimizing the cost for the template regions of the current block and, by spatial proximity, are considered as likely good candidates for predicting samples of the current block. However, the further from the template area the current samples of the current block, the less likely the spatial correlation between template region and current block. Accordingly, applying the same TIMD weights to derive prediction samples may be inaccurate and may result in larger prediction errors. Some location-dependent weights have been introduced as a DIMD technique that relies on HoG amplitudes, which is inapplicable to TIMD.

Embodiments of the present disclosure are related to an approach for improving blending (e.g., combining or fusing) of a plurality of TIMD modes, derived from a plurality of intra prediction modes, to generate a TIMD mode predictor that accounts for spatial proximity of predicted samples to samples of the current template from which the TIMD modes are determined. Specifically, a video coder (e.g., encoder and/or decoder) may determine a directionality (e.g., horizontal, vertical, or diagonal) of each TIMD mode such that weights of the TIMD mode may be adjusted depending on a location of predicted samples. The video coder may determine (e.g., derive) weights of a linear combination of the TIMD modes. For example, a weight for a TIMD mode (e.g., a derived IPM or a non-angular intra prediction mode IPM_{NA}) may be inversely proportional to the cost for the TIMD mode. Then, in some examples, the weights may be adjusted according to a maximum weight value (e.g., a range) to be used in sample-wise blending. In some examples, the maximum weight value is not fixed and may be determined by the video coder (e.g., set or adjusted) based on a size of the current block and/or a picture resolution of the current block.

In some examples, determining the plurality of TIMD modes may include conditionally combining at least one TIMD mode (e.g., two TIMD modes derived from the plurality of intra prediction modes) with a TIMD mode corresponding to a non-angular intra prediction mode (IPM_{NA}). For example, IPM_{NA} may comprise a DC mode or a planar mode. The video coder may determine (e.g., derive) weights of a linear combination of the TIMD mode and the at least one TIMD mode based on costs of the TIMD modes in the linear combination. For example, a weight for a TIMD mode (e.g., a derived IPM or a IPM_{NA}) may be inversely proportional to the cost for that TIMD mode.

In some examples, the video coder may determine whether to combine the TIMD mode, corresponding to a IPM_{NA}, with the at least one TIMD mode to generate the TIMD mode predictor based on whether the at least one TIMD mode comprise the IPM_{NA} and/or comprise at least one IPM_{NA} (e.g., whether the at least one TIMD mode are all angular IPMs). For example, if the at least one TIMD mode do not include any non-angular intra modes and/or do not include the IPM_{NA}, the video coder may determine to combine the at least one TIMD mode with the IPM_{NA}. In other examples, the video coder may further consider one or more criteria to determine whether to combine the at least TIMD mode with the IPM_{NA}. In some examples, the directionality of a TIMD mode may be determined based on computing difference in costs (e.g., SATD, SSE, SAD, etc.) for regions of the current template. For example, the video coder may determine a ratio of a first cost for a first region of the template to a second cost for a second region of the template. For example, the first region may be an above template and the second region may be a left template. By dynamically adjusting weights of one or more TIMD modes for determining prediction samples during the TIMD fusion process, location-dependency of predicted samples or spatial proximity of the predicted samples to the template may be considered. Therefore, the blended intra predictor may better suit the signal characteristics of the blocks to be predicted.

These and other features of the present disclosure are described further below.

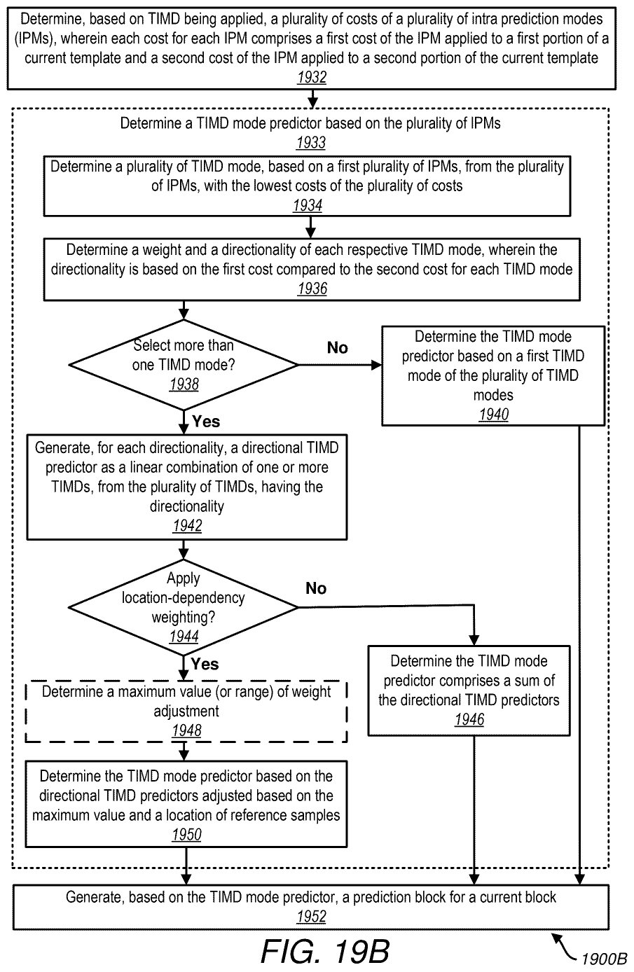

FIG. 19A shows a flowchart 1900A of a method for applying a TIMD technique with directional samplewise fusion for a current block, according to some embodiments. The method of flowchart 1900A may be implemented by a video coder (e.g., encoder 200 in FIG. 2 or decoder 300 in FIG. 3). The method of flowchart may be performed reciprocally (e.g., independently and identically) by an encoder and a decoder such that an intra prediction mode need not be signaled by the encoder to the decoder to reconstruct current block using intra prediction techniques.

At block 1902, the video coder determines, based on TIMD being applied (e.g., enabled) for the current block, a plurality of costs of a plurality of intra prediction modes (IPMs). Each cost for a respective IPM, of the plurality of IPMs, is based on differences between: predicted samples, of a template, generated from the IPM applied to reference samples to the template; and reconstructed samples of the template. Examples of the template of the current block (e.g., template 1704A-B) and the reference of the template (e.g., reference of template 1706) are shown and described with respect to FIG. 17B.

In some examples, the video coder may be a decoder that determines the plurality of costs based on receiving (e.g., parsing and decoding), from a bitstream, an indication of the TIMD being applied (e.g., enabled) for the current block. For example, an encoder may determine that TIMD is applied for coding the current block and signal the indication in the bitstream to the decoder. In some examples, the indication may be a syntax element (e.g., a flag such as timd_flag) that is activated and signaled in the bitstream at the block level (e.g., per block).

At block 1903, the video coder determines a TIMD mode predictor based on the plurality of IPMs. Block 1903 may comprise blocks 1904-1920.

At block 1904, the video coder determines a first TIMD mode and a second TIMD mode, based on a first IPM and a second IPM, from the plurality of IPMs, with the lowest costs of the plurality of costs.

At block 1906, the video coder determines whether to select the second TIMD mode to determine the TIMD mode predictor.

At block 1916, based on the second TIMD mode not being selected, the video coder determines the TIMD mode predictor based on the first TIMD mode. For example, the TIMD mode predictor may be determined to be the first TIMD mode.

At block 1908, based on the second TIMD mode being selected (e.g., to be considered in blending with the first TIMD mode), the video coder determines whether to apply location-dependency weighting. As explained above, the encoder and decoder may independently and reciprocally/identically determine whether to apply location-dependency weighting such that no additional signaling is needed in the bitstream to conditionally enable/select location-dependency weighting. In some embodiments, the video coder determines whether to apply location-dependency weighting based on a directionality determined for each of the selected first and second TIMD modes. For example, if the directionality is determined to be none, then location-dependency weighting may be disabled (e.g., not enabled or not selected) and the location-dependency state may be set to 0 (indicating no location-dependency or diagonal direction).

In some embodiments, the video coder may determine whether to apply location-dependency weighting based on a size of the current block (e.g., a product of the height h_{c} and a width w_{c} of the current block). For example, the video coder may compare the size of the current block with a size threshold T_{C} (e.g., being set to 64).

$$If {h}_{C} \times {w}_{C} \leq {T}_{C} , {locDep}_{i} = 0$$

For example, based on the size being less than or equal to the size threshold, location-dependency weighting may be disabled (e.g., locDepᵢ=0). In alternative implementation with the same result, based on the size being less than the size threshold plus one, location-dependency weighting may be disabled (e.g., if h_{c}×w_{c}<T_{C}+1, locDepᵢ=0)

In some examples, instead of a size threshold being used, a height threshold (T_{Ch}) and a width threshold (T_{Cw}) may be compared, respectively, with a height and a width of the current block to determine whether location-dependency weighting is enabled or disabled. For example, regardless of the location-dependency state (e.g., directionality) determined for the first TIMD mode and/or the second TIMD mode, the location-dependency state of the associated TIMD mode may be set to 0 (e.g., indicating no direction-dependency weighting or diagonal) if the width or height of the current block is less than (or equal to) the width threshold and the height threshold, respectively.

In some examples, the determination for whether location-dependency weighting is enabled or disabled depends on a location-dependency state (indicating a directionality) determined for a selected TIMD mode (e.g., the first TIMD mode or the second TIMD mode) and a length of the current block corresponding to that directionality. For example, if the width (w_{CU}) of the current block is below a threshold (e.g. T_{CUw}=8) and the location-dependency state (locDepᵢ) of a selected TIMD mode (i-th mode) is determined to be horizontal (e.g., locDepᵢ=2), location-dependency state may be inaccurate and thus the video coder may determine to disable location-dependency for that selected TIMD mode (e.g., by setting locDepᵢ to 0). Similarly, if the height (h_{CU}) of the current block is below a threshold (e.g. T_{CUh}=8) and the location-dependency state (locDepᵢ) of the selected TIMD mode is determined to be vertical (e.g., locDepᵢ=1), the location-dependency state may be inaccurate and thus the video coder may determine to disable location-dependency for that selected TIMD mode (e.g., by setting locDepᵢ to 0). These determinations are shown below:

$$\begin{matrix}If {w}_{CU} < {T}_{CU w} \&\& {locDep}_{i} = 2 , {locDep}_{i} = 0 \\ If {h}_{CU} < {T}_{CU h} \&\& {locDep}_{i} = 1 , {locDep}_{i} = 0\end{matrix}$$

In some examples, the size threshold, the height threshold, and/or the width threshold may be predetermined (e.g., predefined or preconfigured) at the encoder and the decoder. In other examples, the encoder may signal, in the bitstream to the decoder, an indication of a value of the size threshold, a value of the height threshold, and/or a value of the width threshold.

At block 1918, based on the location-dependency weighting not being selected/applied/enabled, the video coder determines the TIMD mode predictor comprising a linear combination of the first TIMD mode and the second TIMD mode. Block 1918 may include block 1920. At block 1920, the video coder determines, based on costs of the first TIMD mode and second TIMD mode, respective weights of the first TIMD mode and the second TIMD mode in the linear combination.

In some examples, each weight of a TIMD mode may be determined as being inversely proportional to a cost of the TIMD mode such that a smaller cost (e.g., SSE, SSD, or SADT) is associated with a higher weight. In other words, the TIMD mode with the smaller cost will have a higher weight than that of the other TIMD mode with the higher cost. For example, a first weight (weight1) for the first TIMD mode with a first cost (costMode1) and a second weight (weight2) for the second TIMD mode with a second cost (costMode2) may be determined as follows:

$$weight 1 = \frac{costMode 2}{costMode 1 + costMode 2} \qquad ( 22 )$$

$$weight 2 = 1 - weight 1 = \frac{costMode 1}{costMode 1 + costMode 2} \qquad ( 23 )$$

At block 1910, based on the location-dependency weighting being selected/applied/enabled, the video coder determines the TIMD mode predictor comprising a linear combination of the first TIMD mode, the second TIMD mode, and the linear combination comprises dynamic weights. Block 1910 may include blocks 1912-1915.

In some embodiments, weights (e.g., first and second weights) of the TIMD modes (e.g., first and second TIMD modes) selected to determine the TIMD mode predictor may be determined (e.g., computed) based on costs of the TIMD modes. For example, a weight for a TIMD mode may be determined to be inversely proportional to a cost for the TIMD mode and/or proportional to a difference between a sum of the costs and the cost of the TIMD mode. For example, the weights of the TIMD modes may be determined according to the following equation (24):

$${w}_{i} = \frac{{\sum }_{i = 1}^{n} {costIPM}_{i} - {costIPM}_{i}}{( n - 1 ) \times {\sum }_{i = 1}^{n} {costIPM}_{i}} \qquad ( 24 )$$

wᵢ is the weight associated with the i-th IPM of the i-th TIMD mode. costIPMᵢ is the cost associated with (e.g., determined for) the i-th IPM of the i-th TIMD mode. For example, w₁ represents the first weight of the first TIMD mode and w₂ represents the second weight of the second TIMD mode. n (e.g., 3, 4, etc.) represents the number of TIMD modes to be combined (i.e., in a linear combination with the weights) to generate the TIMD mode predictor.

It should be noted additional weights and directionalities may be determined based on additional TIMD modes being blended. One or more TIMD modes may be selected and be determined/selected from an MPM list or other modes (e.g., DC, horizontal, vertical directions and extended IPM for wide angular IPM).

In some embodiments, directionalities (e.g., first and second directionality) of the TIMD modes (e.g., first and second TIMD modes) are determined based on costs of the TIMD modes. For example, a directionality may include horizontal indicating prediction samples closer to the left boundary of the current block are likely to be more spatially correlated with the parameters (e.g., weight) for the determined TIMD mode, vertical indicating prediction samples closer to the above boundary of the current block are likely to be more spatially correlated with the parameters (e.g., weight) for the determined TIMD mode, no direction, and/or diagonal indicating a combination of horizontal and vertical. In an example, no direction may correspond to and indicate the diagonal direction.

For a selected TIMD mode (e.g., a candidate minimizing a cost computed in the template area), the directionality (indicating location-dependency) may be determined based on which portion(s) of the current template contributes the most to the selection of the TIMD mode. There may be as many location-dependency directionalities as regions of the current template. For instance, a current template may comprise a first region (e.g., template region 1704B) and a second region (e.g., template region 1704A). If it is determined that the above template is the most impactful template for the selection of the TIMD mode, the location-dependency state/indication associated with the selected TIMD mode is set to “vertical” and sample-wise vertical fusion will be operated for blending this TIMD mode. If it is determined that the left template is the most impactful template for the selection of the TIMD mode, the location-dependency state associated with the selected TIMD mode is set to “horizontal” and sample-wise horizontal fusion will be operated for blending this TIMD mode. If the impact of the templates in the selection of the TIMD mode is balanced, the associated location-dependency state for the TIMD mode may be set to “non-location-dependent” and neither horizontal nor vertical sample-wise process is operated (e.g., meaning regular block-wise weight blending is achieved). In other words, a sample-wise diagonal fusion will be operated for blending this TIMD mode. Thus, the location-dependency state associated with a selected TIMD mode impacts directionality of the sample-wise TIMD fusion process. In some examples, the first region and the second region do not overlap. In other examples, they may overlap.

In some examples, the directionality for a TIMD mode may be determined according to availability of template samples and/or template regions. For example, only one template region may be available at the picture border. For example, if only the first region (e.g., left template) is present or available, a first directionality may be determined (e.g., location-dependency being set to 2 indicating horizontal) corresponding to that first region. Similarly, if only the second region (e.g., above template) is present or available, a second directionality may be determined (e.g., location-dependency being set to 1 indicating vertical) corresponding to that second region. In some examples, when the location dependency is determined as being not enabled, (e.g., disabled) the value may be set to, e.g., 0, which may indicate a diagonal direction.

Accordingly, a directionality (e.g., location dependency state/indication) of the TIMD mode may be determined based on one or more template regions being available as follows:

$$If only available template = second region ( e . g . , above template ) , {locDep}_{i} = 1$$

$$Else if only available template = first region ( e . g . , left template ) , {locDep}_{i} = 2$$

$$Otherwise , {locDep}_{i} = 0$$

In some examples, if only one component in the cost calculation (e.g., SATD, SSE, SAD, etc.) is available, the location-dependency may be disabled, e.g., the directionality (e.g., location dependency state) associated with the selected TIMD mode may be disabled (e.g., locDepᵢ=0).

In some examples, the impact may be determined based on comparing a first cost of the first region with a second cost of the second region. The cost may be calculated much like how TIMD costs are calculated, e.g., using SATD, SSE, or SAD. In some examples, a lower cost indicates higher impact. In some examples, a ratio may be calculated between the first cost and the second cost to determine which region has greater impact and thus determine the directionality of the TIMD mode.

For example, for the first cost for the first region (e.g., a left template region/area) and the second cost for the second region (e.g., an above template region/area), determination of the directionality of the TIMD mode may be determined as follows:

$$\begin{matrix}If {SATD}_{A} < k . {SATD}_{L} , {locDep}_{i} = 1 \\ Else if {SATD}_{L} < k . {SATD}_{A} , {locDep}_{i} = 2 \\ Otherwise , {locDep}_{i} = 0\end{matrix}$$

For illustrative purposes, the costs are represented as SATD costs, but other costs are possible. SATD_{A} is the SATD cost associated with a selected TIMD mode and computed in the second region (e.g., above template). SATD_{L} is the SATD cost associated with a selected TIMD mode and computed in the first region (e.g., left template). locDepᵢ is the location-dependent parameter value associated with the i-th selected TIMD mode (e.g., i belongs to [0; 2]). A value of 0 may indicate no location-dependency; a value of 1 may indicate vertical location-dependency of the i-th selected TIMD mode; and a value of 2 may indicate horizontal location-dependency of the i-th selected TIMD mode. k is a scaling factor and, e.g., may be a value less than 1. For example, k may be a value comprised in the range [ 1/10; ⅙] such as ⅛.

In some examples, each of the first and second costs (e.g., represented in the below examples as an SATD cost) may be normalized based on (e.g., against) the number (e.g., quantity) of samples present in the respective template before being compared to determine a directionality (e.g., location-dependency state/indication) of the TIMD mode:

$$\begin{matrix}If {norSATD}_{A} < k . {norSATD}_{L} , {locDep}_{i} = 1 \\ else if {norSATD}_{L} < k . {norSATD}_{A} , {locDep}_{i} = 2 \\ Otherwise , {locDep}_{i} = 0\end{matrix}$$

For example, norSATDₓ represents a normalized cost (e.g., SATD) of template region x (e.g., with x being a first region (e.g., left region) or a second region (e.g., above region). norSATD_{A} and norSATD_{L} may be determined (e.g., calculated) as follows:

$$\begin{matrix}{norSATD}_{A} = \frac{a}{{h}_{T} \times {w}_{CU}} \\ n \\ {orSATD}_{L} = \frac{a}{{w}_{T} \times {h}_{CU}}\end{matrix}$$

h_{T} is the height of the second template region (e.g., the above template). w_{T} is the width of the first template region (e.g., left template). h_{CU} is the height of the current block and w_{CU} is the width of the current block. a is a scaling factor.

For example, these parameters may be determined as follows:

$$\begin{matrix}if {w}_{CU} \leq 8 , {w}_{T} = 2 else {w}_{T} = 4 \\ if {h}_{CU} \leq 8 , {h}_{T} = 2 else {h}_{T} = 4. \\ a = {h}_{CU} \times {w}_{CU}\end{matrix}$$

In some examples, a positive value of a (e.g. a=256) may be selected in case of integer implementation but can be set to 1 for floating point implementation.

In some embodiments, the ratio between costs may be computed between a template SATD and the total SATD (cumulated on all templates) as follows:

$$\begin{matrix}If {SATD}_{L} > k . {SATD}_{+} , {locDep}_{i} = 1 \\ else if {SATD}_{A} > k . {SATD}_{+} , {locDep}_{i} = 2 \\ Otherwise , {locDep}_{i} = 0\end{matrix}$$

For example, k may be in the range of [0.5; 1]. SATD₊ may indicate the cumulated SATD, e.g., over the first and second template regions (e.g., over both above and left templates). In these examples, the logic here is shifted as it considers that if most part of the total SATD cost comes from a template (e.g. left template), then the location-dependency is toward the other template (e.g. above template so vertical location-dependency state) as a minimal SATD cost means a better prediction.

In some examples, when a candidate TIMD mode is non-angular (e.g. DC or Planar mode), the associated location-dependency state (e.g., directionality) may be set to 0 (e.g., indicating no-location-dependency) as it is expected that these “flat” modes when selected do not exhibit large differences in terms of relative template cost (e.g., SATD). However, in other examples, a location-dependency state may be determined (e.g., derived) for the candidate non-angular TIMD mode similar to how the location-dependency state is determined for an angular TIMD mode, as described above.

In some examples, a directionality of a non-angular mode may be derived/determined based on a plurality of directional non-angular modes (e.g., directional DC, directional planar) corresponding to that non-angular mode. For example, the directionality may be determined as being corresponding to direction of the lowest cost (e.g., SATD cost) of the directional non-angular modes (e.g., among vertical, horizontal and original modes). For instance, template (e.g., SATD) cost may be computed for original, horizontal, and vertical Planar modes. If horizontal planar mode has the minimum SATD cost among the three planar modes, location-dependency or the directionality for the planar mode may be se to horizontal. If vertical planar mode has the minimum SATD cost among the three planar modes, location-dependency or the directionality for the planar mode may be set to vertical. Otherwise, if the original planar mode has the minimum SATD cost, then the directionality may be set to diagonal (or possibly sample-wise fusion is deactivated). It is noted that although a directional non-angular mode has a lowest SATD cost, the regular original non-angular mode may be used during the fusion process. As noted above, examples are described with respect to SATD costs, but other types of costs may be used instead, e.g., SAD, SSE, etc.

At block 1912, the video coder determines a first weight and a first directionality of the first TIMD mode, as explained above. At block 1914, the video coder determines a second weight and a second directionality of the second TIMD mode, as explained above.

At block 1915, the video coder determines a range of weight adjustment (e.g., Δᵢ) for which to vary weights of the location-dependent TIMD modes. In some examples, the range of weight adjustment (e.g., a maximum weight value or a maximum weight deviation) of the sample-based DIMD fusion process may be a fixed value such as 10 (Δᵢ=10). In some examples, the range of weight adjustment may be determined based on a current block size and/or a number of samples in the picture (e.g., a picture resolution). In other words, the range of weight adjustment may be dynamically and reciprocally/identically determined by the encoder and decoder for different pictures and/or different sized blocks.

Advantageously, the larger the selected current block, the less predictor samples variations may be desired (e.g., flatter predictor) meaning that a reduction of sample-based weight range may increase the accuracy of the blended predictor. As an example, the range of weight adjustment may be determined based on a size of the current block as follows:

$$\begin{matrix}If {h}_{CU} \times {w}_{CU} > T - 1 , {Δ}_{i} = F - O \\ Otherwise , {Δ}_{i} = F\end{matrix}$$

where: h_{CU} is the height of the current block (CU); w_{CU} is the width of the current block (CU); T is representative of a current block (CU) size threshold above which 4; is changed. For example, T={128; 256}. F is a fixed value, e.g., F={8; 10}. O is an offset value to apply to the fixed value under conditions, e.g., O={2; 3}.

Also, the same reasoning may apply to the number of samples in the picture where variations of TIMD weight spanning over the block (CU) for larger picture resolutions should be reduced. As an example, the range of weight adjustment may be determined based on a size of the picture (e.g., a resolution of the picture of the current block) as follows:

$$\begin{matrix}If {h}_{pic} \times {w}_{pic} > S , {Δ}_{i} = F - O \\ Otherwise , {Δ}_{i} = F\end{matrix}$$

where: h_{pic} is the height of the current picture; w_{pic} is the width of the current picture; S is representative of a picture size threshold (e.g., characterized by a number of luma samples) above which Δᵢ is changed. For example, S=1280×720. O is an offset value to apply to the fixed value under conditions, e.g., O={2; 3}.

In some examples, the range of weight adjustment (Δᵢ) may be determined (e.g., adapted or adjusted) based on both the size of the current block and the number of samples in the picture as follows:

$$\begin{matrix}If ( {h}_{CU} \times {w}_{CU} > T - 1 ) \&\& ( {h}_{pic} \times {w}_{pic} > S ) , {Δ}_{i} = F - O \\ Otherwise , {Δ}_{i} = F\end{matrix}$$

where: h_{CU} is the height of the current block; w_{CU} is the width of the current block; h_{pic} is the height of the current picture; w_{pic} is the width of the current picture; T is representative of a current block size threshold above which Δᵢ is changed. For example, T={128; 256}. S is representative of a picture size threshold (characterized by a number of luma samples) above which 4; is changed. For example, T=1280×720. F is a fixed value, e.g., F={8; 10}. O is an offset value to apply to the fixed value under conditions, e.g., O={2; 3}.

$${IPM}_{TIMD} = {\sum }_{i = 1}^{n} {w}_{i} \times {IPM}_{i}$$

predictor comprises a linear combination of a number of are selected at block 1918 or 1910). The linear combination comprises the weights determined for the TIMD modes, as described above with respect to blocks 1910 and 1918. For example, the TIMD mode predictor (IPM_{TIMD}) may be determined according to the linear combination (29) below:

$${IPM}_{TIMD} = {\sum }_{i = 1}^{n} {w}_{i} \times {IPM}_{i} \qquad ( 29 )$$

wᵢ may be the weight for an i-th TIMD mode comprising an i-th IPM. As described above, a weight (wᵢ) may be location-dependent according to a determined range of weight adjustment (e.g., a maximum weight deviation/value) and a directionality determined for an i-th TIMD mode.

At block 1922, the video coder generates, based on the TIMD mode predictor, a prediction block for the current block. For example, the video coder may apply the TIMD mode predictor to the template of the current block to generate the prediction block for the current block (e.g., as described above with respect to FIGS. 10-12 and 17B).

In some examples, based on location-dependency for the TIMD mode predictor being determined/selected/enabled, the TIMD predictor, which is generated and applied sample-by-sample, may vary for each sample. Specifically, the TIMD predictor changes for each reference sample depending on a position/location of the reference sample and location-dependency parameter (which determines the direction of the sample-wise blending). For example, the location-dependent weight may vary depending on a position of a predicted sample to be generated using the TIMD mode predictor (IPM_{TIMD}).

In some examples, when the video coder is a decoder, the decoder may reconstruct the current block based on the prediction block and a residual (e.g., a prediction error or a residual block). For example, the decoder may receive (e.g., decode) the residual from a bitstream.

In some examples, when the video coder is an encoder, the encoder may determine (e.g., generate) the residual based on a difference between the prediction block and current block. The encoder may encode the determined residual in the bitstream.

FIG. 19B shows a flowchart 1900B of a method for applying a TIMD technique with directional samplewise fusion for a current block, according to some embodiments. The method of flowchart 1900B may be implemented by a video coder (e.g., encoder 200 in FIG. 2 or decoder 300 in FIG. 3). The method of flowchart may be performed reciprocally/identically by an encoder and a decoder such that an intra prediction mode need not be signaled by the encoder to the decoder to reconstruct current block using intra prediction techniques. In some examples, many operations shown in flowchart 1900B may be performed similarly as those in flowchart 1900A.

At block 1932, the video coder determines, based on TIMD being applied (e.g., enabled) for the current block, a plurality of costs of a plurality of intra prediction modes (IPMs). In some examples, each cost for each IPM may include a first cost of the IPM applied to a first portion of a current template (e.g., to predict the first portion) and include a second cost of the IPM applied to a second portion of the current template (e.g., to predict the second portion). In some examples, the current template comprises the first portion and the second portion. In an example, the first and second portions may be non-overlapping. For example, the first and second portion may comprise samples to the left of the current block and samples above the current block, respectively. In another example, the first and second portions may overlap. Each of the first and second costs may be similarly calculated as the cost as described in block 1902.

At block 1933, the video coder determines a TIMD mode predictor based on the plurality of IPMs. Block 1903 may comprise blocks 1933-1950.

At block 1934, the video coder determines a plurality of TIMD modes, based on a first plurality of IPMs, from the plurality of IPMs, with the lowest costs of the plurality of costs. In some examples, block 1934 may correspond to block 1904. At block 1934, more than two TIMD modes may be determined, e.g., based on an n number of IPMs with the n smallest costs.

At block 1936, the video coder determines a weight and a directionality of each respective TIMD mode, of the plurality of TIMD modes. The directionality of each TIMD mode may be determined based on the first cost compared to the second cost for each TIMD mode. For example, the directionality may be associated with a smaller cost. For example, the directionality may be determined based on a difference or a ratio of the first cost and the second cost. In some examples, additional details for calculating the directionality are provided with respect to blocks 1912 and 1914.

At block 1938, the video coder determines whether to select the second TIMD mode to determine the TIMD mode predictor. In some examples, block 1938 may correspond to block 1906.

At block 1940, based on the second TIMD mode not being selected, the video coder determines the TIMD mode predictor based on the first TIMD mode. For example, the TIMD mode predictor may be determined to be the first TIMD mode. In some examples, block 1940 may correspond to block 1916.

At block 1942, the video coder generates, for each directionality, a directional TIMD predictor as a linear combination of one or more TIMDs, from the plurality of TIMDs, having the directionality.

At block 1944, based on the second TIMD mode being selected (e.g., to be considered in blending with the first TIMD mode), the video coder determines whether to apply location-dependency weighting. In some examples, block 1944 may correspond to block 1908.

At block 1946, based on location-dependency weighting not being applied, the video coder determines the TIMD mode predictor comprises a sum of the directional TIMD predictors determined at block 1942. In some examples, the resulting TIMD mode predictor of 1946 is equivalent to the TIMD mode predictor determined at block 1918.

At block 1948, the video coder determines a maximum value (or range) of weight adjustment to be applied for location-dependency weighting. In some examples, block 1948 corresponds to block 1915. In some examples, the range of weight adjustment may be a fixed value. In some examples, the range of weight adjustment may be determined based on a size of the current block and/or a picture size/resolution, as described above with respect to block 1915.

At block 1950, the video coder determines the TIMD mode predictor based on the directional TIMD predictors adjusted based on the maximum value and a location of reference samples. The TIMD mode predictor is applied sample-by-sample to reference samples (e.g., samples of the current template) to derive predicted samples of a prediction block for the current block, as explained above with respect to block 1910.

At block 1952, the video coder generates, based on the TIMD mode predictor, a prediction block for the current block. In some examples, block 1952 may correspond to block 1922.

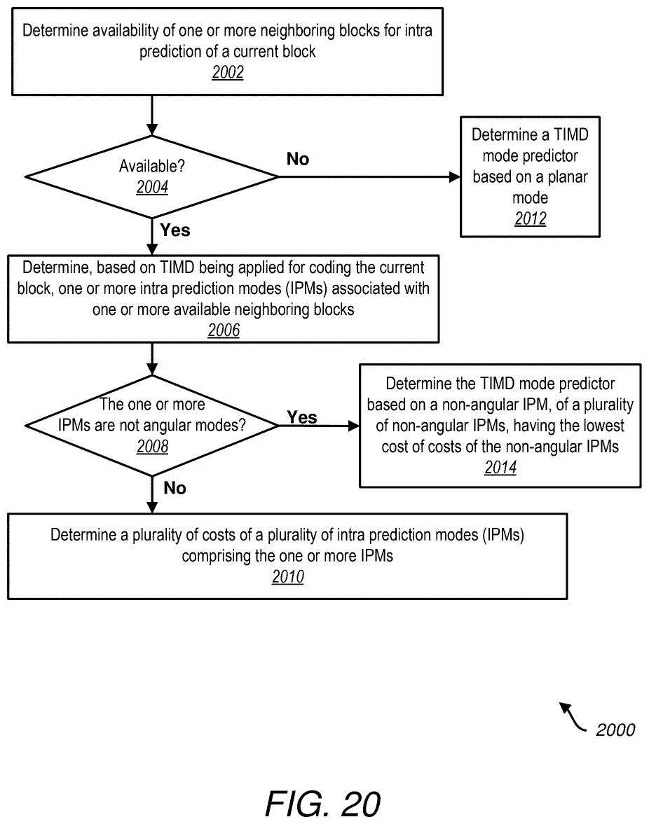

FIG. 20 shows a flowchart 2000 of an example method for applying a TIMD technique with directional samplewise fusion for a current block, according to some embodiments. The method of flowchart 2000 may be implemented by a video coder (e.g., encoder 200 in FIG. 2 or decoder 300 in FIG. 3). The method of flowchart may be performed reciprocally/identically by an encoder and a decoder such that an intra prediction mode need not be signaled by the encoder to the decoder to reconstruct current block using intra prediction techniques. In some examples, one or more operations of flowchart 2000 may be performed before block 1903 of FIG. 19A or before block 1933 of FIG. 19B.

At block 2002, the video coder determines availability of one or more neighboring blocks for intra prediction of a current block. For example, the one or more neighboring blocks may be spatial candidate blocks neighboring the current block, as described above with respect to FIG. 15A. Examples of these neighboring blocks may include a block to the left, above, above left, below left, and above right related to the current block. In some examples, based on one or more of the neighboring blocks being available, the video coder may determine intra prediction modes of the one or more available neighboring blocks.

As described above with respect to FIG. 17B, to perform TIMD, the video coder may determine a template of the current block and a reference of the template. For example, the template may comprise template regions, from a reconstructed region of a picture of the current block, defined relative to a position of the current block. The template regions may include a left template region adjacent to the current block and an above template region adjacent to the current block. For example, the reference of the template may comprise samples of regions, from the reconstructed region, defined relative to the position of the current block and/or a position of the template. In some examples, regions of the template and the reference of the template may be further based on which of neighboring blocks are available.

At block 2012, based on the one or more neighboring blocks being unavailable (e.g., based on none of the neighboring blocks of the current block being available) at block 2004, the video coder determines a TIMD mode predictor based on a planar mode. For example, the TIMD mode predictor may be determined as the planar mode.

At block 2006, based on the one or more neighboring blocks being available at block 2004, the video coder determines one or more intra prediction modes (IPMs) associated with one or more available neighboring blocks. In some examples, the determination of the one or more IPMs may be based on TIMD being applied for coding the current block.

At block 2008, the video coder determines whether the one or more IPMs are not angular intra-prediction modes (IPMs). At block 2014, based on the one or more IPMs being not angular IPMs, the video coder determines the TIMD mode predictor based on a non-angular IPM of a plurality of non-angular IPMs. Examples of non-angular IPMs are described above in FIG. 17B and FIGS. 19A-B.

In an example, the video coder determines the TIMD mode based on the non-angular IPM in response to (e.g., based on) at least one of the one or more IPMs being a non-angular IPM of at least two different IPMs. In some examples, the video coder may select the non-angular IPM with the lowest cost (e.g., SAD, SATD, SSE, etc.), of costs of the plurality of non-angular IPMs, as the TIMD mode predictor.

In some examples, the video coder may determine whether a number of the one or more IPMs being not angular modes is greater than or equal to a threshold number. For example, the threshold number may be set based on a number of available neighboring blocks of the current block and/or a number of different IPMs of available neighboring blocks. For example, if at least 3 neighboring blocks are available, then the threshold number may be set to 2 with at least 2 modes of the IPMs of the available neighboring block being different. For example, if only 1 or 2 neighboring blocks are available, then the threshold number may be set to 1.

At block 2010, the video coder determines a plurality of costs of a plurality of IPMs comprising the one or more IPMs (e.g., referenced in block 2006 and block 2008). In some examples, block 2010 may correspond to block 1902 of FIG. 19A and the video coder may perform the same or similar operations.

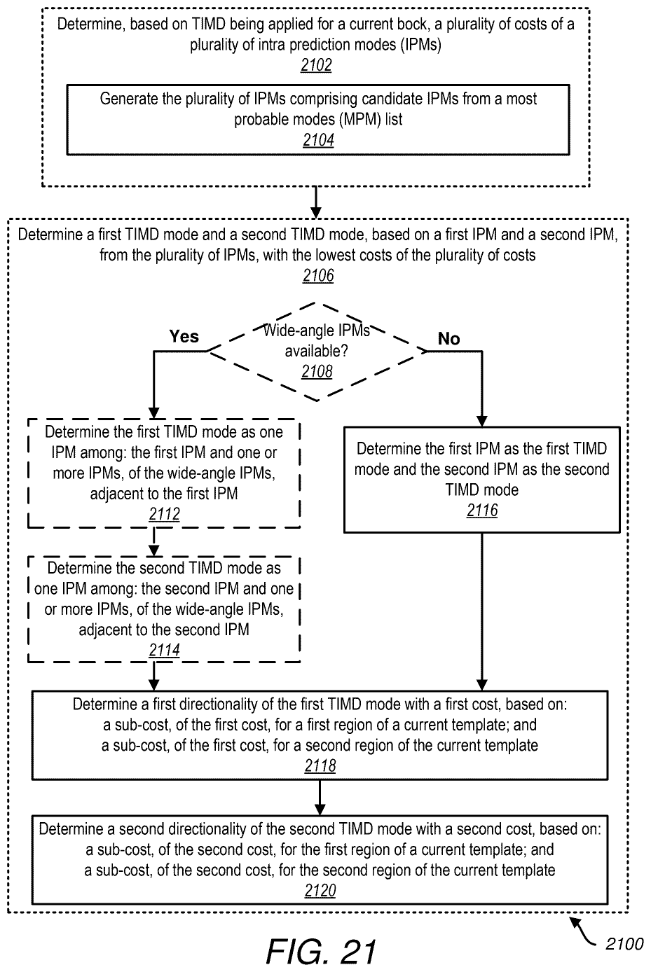

FIG. 21 shows a flowchart 2100 of an example method for applying a TIMD technique with directional samplewise fusion for a current block, according to some embodiments. The method of flowchart 2100 may be implemented by a video coder (e.g., encoder 200 in FIG. 2 or decoder 300 in FIG. 3). The method of flowchart may be performed reciprocally/identically by an encoder and a decoder such that an intra prediction mode need not be signaled by the encoder to the decoder to reconstruct current block using intra prediction techniques. In some examples, flowchart 2100 shows more detailed operations corresponding to block 1902 and block 1904 of FIG. 19A and/or block 1932 and block 1934 of FIG. 19B.

At block 2102, the video coder determines, based on TIMD being applied for a current block, a plurality of costs of a plurality of intra prediction modes (IPMs). In some examples, block 2102 corresponds to block 1902 of FIG. 19A and the video coder may perform the same or similar operations. Block 2102 may include block 2104.

At block 2104, the video coder generates the plurality of IPMs comprising candidate IPMs from a most probable modes (MPM) list. In some examples, the plurality of IPMs may further comprise a DC mode, a planar mode, a vertical planar mode, a horizontal planar mode, a vertical DC mode, a horizontal DC mode, or a combination thereof. Then, the cost for each IPM in the MPM list is determined and correspond to each cost of the plurality of costs.

In some examples, the MPM list may be generated for each block to for use in an intra prediction mode. For example, for signaling an intra prediction mode (IPM), the encoder may encode an index, into the MPM list, indicating a selected IPM. Using the MPM list may reduce the number of bits involved in signaling indexes of chosen IPMs. In some examples, the MPM list comprises 22 candidate IPMs. For example, the MPM list comprises a first portion (e.g., 6 IPMs) of candidate IPMs referred to as a primary MPM list. The primary MPMs are planar intra prediction mode, an IPM from a left neighboring block, an IPM from an above neighboring block, an IPM from a below-left neighboring block, an IPM from an above-right neighboring block and an IPM from an above-left neighboring block, as described with respect to FIG. 15A. The MPM list may comprise a second portion (e.g., the next 16 candidate IPMs) of candidate IPMs referred as a secondary MPM list. The secondary MPM list includes or consists of IPMs derived by offsets from the IPMs in the primary MPM list. In some examples, one or more decoder decoder-side intra mode derivation (DIMD) modes may be added to the MPM list after the primary MPMs and before the secondary MPMs in the final MPM list. In some examples, other IPMs not included in the MPM list are included in a separate, non-MPM list.

At block 2106, the video coder determines a first TIMD mode and a second TIMD mode, based on a first IPM and a second IPM, from the plurality of IPMs, with the lowest costs of the plurality of costs. In some examples, block 2106 corresponds to block 1904 of FIG. 19A and/or block 1934 of FIG. 19B, and the video coder may perform the same or similar operations. Block 2106 may include blocks 2108-2120.

At block 2108, the video coder determines whether wide-angle IPMs are available for intra prediction. In some examples, as shown in dotted lines, wide-angle IPMs are not configured and blocks 2108, 2112, and 2114 may be omitted from flowchart 2100.

At block 2116, based on the wide-angle IPMs being unavailable or not used, the video coder determines the first TIMD mode comprises the first IPM (e.g., the first TIMD mode is determined as the first IPM) and the second TIMD mode comprises the second IPM (e.g., the second TIMD mode is determined as the second IPM).

In some examples, based on the wide-angle IPM being available, a number of available angular IPMs may be extended from a first range (e.g., 67 modes) to a second range (e.g., 131 modes) and each of the first IPM and the second IPM may be refined (e.g., adjusted) to determine the first TIMD mode and the second TIMD mode.

At block 2112, based on the wide-angle IPMs being available, the video coder determines the first TIMD mode as one IPM among: the first IPM and one or more IPMs, of the wide-angle IPMs, adjacent to the first IPM. For example, the one or more IPMs may be determined as the two adjacent IPM modes (e.g., +/−1 IPM) adjacent to the first IPM.

At block 2114, based on the wide-angle IPMs being available, the video coder determines the second TIMD mode as one IPM among: the second IPM and one or more IPMs, of the wide-angle IPMs, adjacent to the second IPM. Blocks 2112 and 2114 may be performed in any order. For example, the one or more IPMs may be determined as the two adjacent IPM modes (e.g., +/−1 IPM) adjacent to the second IPM.

At block 2118, the video coder determines a first directionality of the first TIMD mode with a first cost, based on: a sub-cost, of the first cost, for a first region of a current template; and a sub-cost, of the first cost, for a second region of the current template. At block 2120, the video coder similarly determines a second directionality of the second TIMD mode with a second cost, based on: a sub-cost, of the second cost, for the first region of the current template; and a sub-cost, of the second cost, for the second region of the current template. In some examples, the directionality for each TIMD mode may be determined as described with respect to block 1942 and blocks 1912-1914.

In some embodiments, dynamic weights may be advantageously determined for TIMD modes that are blended (e.g., combined or fused) in a TIMD fusion process. For example, a decoder may receive a bitstream comprising encoded video data and an indication of TIMD being enabled/applied/selected for a current block. Based on TIMD being enabled for the current block, the decoder may determine a current template of the current block, where the current template comprises a first region and a second region of reconstructed samples. For example, the first region and the second region may correspond to samples to the left and above the current template, respectively.

In some examples, the decoder may determine a plurality of TIMD modes (e.g., 2 or 3) to be combined to generate a TIMD mode predictor. For example, a number or limit of the TIMD modes may be set to a predefined number N. Each TIMD may be selected based on costs calculated for each IPM, of a plurality of IPMs, applied to generate predicted samples for the reference samples (i.e., current template samples) of the current template. In some examples, a weight and a directionality (e.g., a location-dependency state) of each selected TIMD mode may be determined based on comparing a first cost for the first region and a second cost for the second region. The directionality may indicate or correspond to a direction in a sample-wise directional predictors fusion process.

In some examples, the weight for the TIMD mode, in the TIMD mode predictor, may be adjusted based on location of samples in accordance with a range of weight adjustments (e.g., a maximum weight deviation/value). In some examples, the range of weight adjustments may be a fixed value. In some embodiments, the range of weight adjustments may be determined based on a size of the current block and/or a picture size/resolution.

In some examples, the TIMD mode predictor may be determined according to the blending weights and the directionality of each TIMD mode in the TIMD mode predictor. The TIMD mode predictor may be used by the decoder to generate a prediction block to decode the current block.

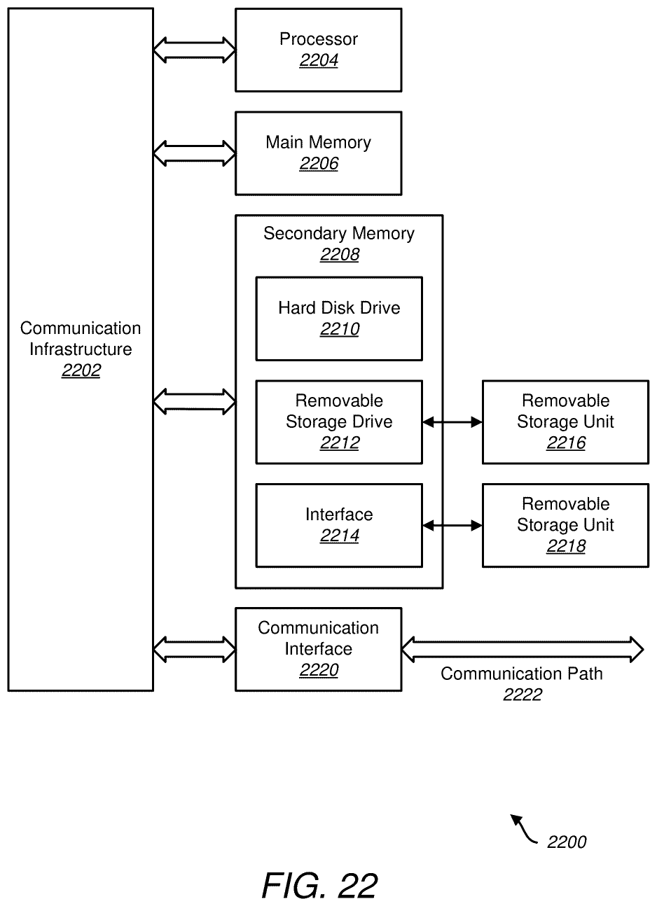

Embodiments of the present disclosure may be implemented in hardware using analog and/or digital circuits, in software, through the execution of instructions by one or more general purpose or special-purpose processors, or as a combination of hardware and software. Consequently, embodiments of the disclosure may be implemented in the environment of a computer system or other processing system. An example of such a computer system 2200 is shown in FIG. 22. Blocks depicted in the figures above, such as the blocks in FIGS. 1, 2, and 3, may execute on one or more computer systems 2200. Furthermore, each of the steps of the flowcharts depicted in this disclosure may be implemented on one or more computer systems 2200.

Computer system 2200 includes one or more processors, such as processor 2204. Processor 2204 may be, for example, a special purpose processor, general purpose processor, microprocessor, or digital signal processor. Processor 2204 may be connected to a communication infrastructure 2202 (for example, a bus or network). Computer system 2200 may also include a main memory 2206, such as random access memory (RAM), and may also include a secondary memory 2208.

Secondary memory 2208 may include, for example, a hard disk drive 2210 and/or a removable storage drive 2212, representing a magnetic tape drive, an optical disk drive, or the like. Removable storage drive 2212 may read from and/or write to a removable storage unit 2216 in a well-known manner. Removable storage unit 2216 represents a magnetic tape, optical disk, or the like, which is read by and written to by removable storage drive 2212. As will be appreciated by persons skilled in the relevant art(s), removable storage unit 2216 includes a computer usable storage medium having stored therein computer software and/or data.

In alternative implementations, secondary memory 2208 may include other similar means for allowing computer programs or other instructions to be loaded into computer system 2200. Such means may include, for example, a removable storage unit 2218 and an interface 2214. Examples of such means may include a program cartridge and cartridge interface (such as that found in video game devices), a removable memory chip (such as an EPROM or PROM) and associated socket, a thumb drive and USB port, and other removable storage units 2218 and interfaces 2214 which allow software and data to be transferred from removable storage unit 2218 to computer system 2200.

Computer system 2200 may also include a communications interface 2220. Communications interface 2220 allows software and data to be transferred between computer system 2200 and external devices. Examples of communications interface 2220 may include a modem, a network interface (such as an Ethernet card), a communications port, etc. Software and data transferred via communications interface 2220 are in the form of signals which may be electronic, electromagnetic, optical, or other signals capable of being received by communications interface 2220. These signals are provided to communications interface 2220 via a communications path 2222. Communications path 2222 carries signals and may be implemented using wire or cable, fiber optics, a phone line, a cellular phone link, an RF link, and other communications channels.

As used herein, the terms “computer program medium” and “computer readable medium” are used to refer to tangible storage media, such as removable storage units 2216 and 2218 or a hard disk installed in hard disk drive 2210. These computer program products are means for providing software to computer system 2200. Computer programs (also called computer control logic) may be stored in main memory 2206 and/or secondary memory 2208. Computer programs may also be received via communications interface 2220. Such computer programs, when executed, enable the computer system 2200 to implement the present disclosure as discussed herein. In particular, the computer programs, when executed, enable processor 2204 to implement the processes of the present disclosure, such as any of the methods described herein. Accordingly, such computer programs represent controllers of the computer system 2200.

In another embodiment, features of the disclosure may be implemented in hardware using, for example, hardware components such as application-specific integrated circuits (ASICs) and gate arrays. Implementation of a hardware state machine to perform the functions described herein will also be apparent to persons skilled in the art.

What is claimed is:

1. A method comprising:
determining, based on template-based intra mode derivation (TIMD) being applied for a current block, a plurality of costs of a plurality of intra prediction modes (IPMs) applied to predict a template of the current block;
determining TIMD modes based on IPMs from the plurality of IPMs;
for each of the TIMD modes:
determining a weight based on a cost of the TIMD mode; and
determining a directionality of the TIMD mode, based on comparing:
a first sub-cost, of the cost, for a first region of the template; and
a second sub-cost, of the cost, for a second region of the template;
determining a TIMD mode predictor based on a linear combination of the TIMD modes having weights that are adjusted according to the directionalities of the TIMD modes; and
generating, based on the TIMD mode predictor, a prediction block for the current block.

2. The method of claim 1, wherein the first region is associated with a first directionality and the second region is associated with a second directionality, and wherein the directionality is selected from at least the first directionality or the second directionality.

3. The method of claim 2, wherein the first region comprises reconstructed samples to the left of the current block and the second region comprises reconstructed samples above the current block, and wherein the first directionality is horizontal and the second directionality is vertical.

4. The method of claim 2, wherein the directionality corresponds to the first region further based on the first sub-cost being smaller than the second sub-cost multiplied by a scaling factor.

5. The method of claim 4, wherein the first sub-cost and the second sub-cost are normalized into a first normalized sub-cost and a second normalized sub-cost, respectively, before being compared, wherein the first sub-cost is normalized to the first normalized sub-cost based on the number of samples in the first region, and wherein the second sub-cost is normalized to the second normalized sub-cost based on the number of samples in the second region.

6. The method of claim 1, further comprising:
determining a range of weight adjustment for adjusting weights of TIMD modes according to the directionalities, wherein the range of weight adjustment is determined based on a predetermined value, a size of the current block, or a resolution of a picture comprising the current block.

7. The method of claim 1, wherein the generating the prediction block comprises applying the TIMD mode predictor to reference samples to determine predicted samples in the prediction block, and wherein the weight for a TIMD mode, in the linear combination, is adjusted based on a position of a reference sample and the directionality of the TIMD mode.

8. A decoder comprising:
one or more processors; and
memory storing instructions that, when executed by the one or more processors, cause the decoder to:
determine, based on template-based intra mode derivation (TIMD) being applied for a current block, a plurality of costs of a plurality of intra prediction modes (IPMs) applied to predict a template of the current block;
determine TIMD modes based on IPMs from the plurality of IPMs;
for each of the TIMD modes:
determine a weight based on a cost of the TIMD mode; and
determine a directionality of the TIMD mode, based on comparing:
a first sub-cost, of the cost, for a first region of the template; and
a second sub-cost, of the cost, for a second region of the template;
determine a TIMD mode predictor based on a linear combination of the TIMD modes having weights that are adjusted according to the directionalities of the TIMD modes; and
generate, based on the TIMD mode predictor, a prediction block for the current block.

9. The decoder of claim 8, wherein the first region is associated with a first directionality and the second region is associated with a second directionality, and wherein the directionality is selected from at least the first directionality or the second directionality.

10. The decoder of claim 9, wherein the first region comprises reconstructed samples to the left of the current block and the second region comprises reconstructed samples above the current block, and wherein the first directionality is horizontal and the second directionality is vertical.

11. The decoder of claim 9, wherein the directionality corresponds to the first region further based on the first sub-cost being smaller than the second sub-cost multiplied by a scaling factor.

12. The decoder of claim 11, wherein the first sub-cost and the second sub-cost are normalized into a first normalized sub-cost and a second normalized sub-cost, respectively, before being compared, wherein the first sub-cost is normalized to the first normalized sub-cost based on the number of samples in the first region, and wherein the second sub-cost is normalized to the second normalized sub-cost based on the number of samples in the second region.

13. The decoder of claim 8, wherein the instructions further cause the decoder to:
determine a range of weight adjustment for adjusting weights of TIMD modes according to the directionalities, wherein the range of weight adjustment is determined based on a predetermined value, a size of the current block, or a resolution of a picture comprising the current block.

14. The decoder of claim 8, wherein to generate the prediction block, the instructions further cause the decoder to apply the TIMD mode predictor to reference samples to determine predicted samples in the prediction block, and wherein the weight for a TIMD mode, in the linear combination, is adjusted based on a position of a reference sample and the directionality of the TIMD mode.

15. A non-transitory computer-readable medium comprising instructions that, when executed by one or more processors of an apparatus, cause the apparatus to:
determine, based on template-based intra mode derivation (TIMD) being applied for a current block, a plurality of costs of a plurality of intra prediction modes (IPMs) applied to predict a template of the current block;
determine TIMD modes based on IPMs from the plurality of IPMs;
for each of the TIMD modes:
determine a weight based on a cost of the TIMD mode; and
determine a directionality of the TIMD mode, based on comparing:
a first sub-cost, of the cost, for a first region of the template; and
a second sub-cost, of the cost, for a second region of the template;
determine a TIMD mode predictor based on a linear combination of the TIMD modes having weights that are adjusted according to the directionalities of the TIMD modes; and
generate, based on the TIMD mode predictor, a prediction block for the current block.

16. The non-transitory computer-readable medium of claim 15, wherein the first region is associated with a first directionality and the second region is associated with a second directionality, and wherein the directionality is selected from at least the first directionality or the second directionality.

17. The non-transitory computer-readable medium of claim 16, wherein the first region comprises reconstructed samples to the left of the current block and the second region comprises reconstructed samples above the current block, and wherein the first directionality is horizontal and the second directionality is vertical.

18. The non-transitory computer-readable medium of claim 16, wherein the directionality corresponds to the first region further based on the first sub-cost being smaller than the second sub-cost multiplied by a scaling factor, wherein the first sub-cost and the second sub-cost are normalized into a first normalized sub-cost and a second normalized sub-cost, respectively, before being compared, wherein the first sub-cost is normalized to the first normalized sub-cost based on the number of samples in the first region, and wherein the second sub-cost is normalized to the second normalized sub-cost based on the number of samples in the second region.

19. The non-transitory computer-readable medium of claim 15, wherein the instructions further cause the apparatus to:
determine a range of weight adjustment for adjusting weights of TIMD modes according to the directionalities, wherein the range of weight adjustment is determined based on a predetermined value, a size of the current block, or a resolution of a picture comprising the current block.

20. The non-transitory computer-readable medium of claim 15, wherein to generate the prediction block, the instructions further cause the apparatus to apply the TIMD mode predictor to reference samples to determine predicted samples in the prediction block, and wherein the weight for a TIMD mode, in the linear combination, is adjusted based on a position of a reference sample and the directionality of the TIMD mode.
